(19) United States
(12) Patent Application Publication
(10) Pub. No.: US 2011/0300265 A1
(43) Pub. Date: Dec. 8, 2011

(54) Pan release compositions for preparation of long shelf life, bakery products

(75) Inventors: GuoHua Feng, Overland Park, KS (US); Jesse Stinson, Lenexa, KS (US)

(73) Assignee: Caravan Ingredients Inc., Lenexa, KS (US)

(21) Appl. No.: 12/802,503

(22) Filed: Jun. 8, 2010

(51) Int. Cl. A21D 8/00; A23L 3/3463; A21D 8/08; A23L 3/3454; A23D 9/06; A21D 15/08

(52) U.S. Cl. 426/64; 426/609; 426/331; 426/323; 426/541; 426/89; 426/94; 426/61

(57) ABSTRACT

The present invention is directed to methods and compositions for making dough- and batter-based bakery foods, such as bread and cake having extremely long, mold-free and freshness shelf lives, by using a novel antimicrobial pan release agent comprising an essential oil dispersed or dissolved in a fat- or oil-based carrier, along with other natural or chemical antimicrobial agents, anti-staling enzymes, and/or flavor enhancement systems. The invention is also directed to the methods and compositions for preparing all-natural dough- and batter-based bakery products, such as bread and cake having long mold-free shelf lives, by treating the surface of the dough, batter, or baked product with the antimicrobial pan release agent, in conjunction with anti-staling enzymes and natural preservatives in the dough or batter formulations. Further, the invention is concerned with all-natural bakery products having extremely long, mold-free shelf lives which are substantially free (both internally and on the exterior surface) of chemical preservatives and antimicrobial agents other than the all-natural antimicrobial pan release agent and optional natural antimicrobial agents inside the dough.

### BACKGROUND OF THE INVENTION

1. Field of the Invention

The present invention relates to novel bakery products having exceptionally long shelf lives, superior mold growth inhibition, greatly improved flavor profiles throughout these shelf lives, and other advantageous properties. The invention is also directed towards novel methods of making such bakery products using an inventive pan release agent. Furthermore, these properties can be achieved even without the use of chemical additives and preservatives.

2. Description of Related Art

The growth of microorganisms, such as mold, rope, spoilage yeast, and bacteria is often the limiting factor in the shelf life of foods. This is especially true for bakery products, such as bread, due to their relatively higher moisture content, higher pH, and the exposure to open air during cooling. The microbial growth not only shortens the shelf life of the bakery products, but also results in difficulties in production, storage and distribution, and sales. A significant amount of such food is wasted either in the store or in consumers' homes due to the microbial growth. In addition to the mold growth, dough-based products, such as bread, also stale (firming and loss of flavor and taste) over time. Although current enzyme technology (such as anti-staling enzymes) has greatly alleviated the staling problem, most bakery products still have very limited shelf lives, due to problems of mold growth, staling, and simultaneous loss of flavor and taste. Among the problems associated with the shelf life of bakery products, mold growth has probably become the most critical limiting factor that will determine the shelf life of future bakery products.

Various methods and preservatives are used in the food industry to inhibit the microbial growth in bakery products. The preservatives commonly used in bakery products are often chemical-based, such as calcium propionate, potassium sorbate, etc. These chemical preservatives are not only label-unfriendly to consumers, but also inhibit yeast fermentation, impart an off-flavor to the finished products, and increase the formula and production cost. A number of solutions have been developed to minimize the negative impact of using the above-mentioned chemical preservatives. These include topical spraying of sorbate solution or using encapsulated sorbic acid or propionate that only release the mold inhibitors during the baking stage. Natural preservatives, such as vinegar, raisin juice concentrate, and fermented sugars, etc. are used for mold inhibition in all-natural bakery products. However, these preservatives not only have limited effectiveness in mold inhibition, but also inhibit yeast fermentation, affect the flavor and taste of the final products, and are often much more expensive to use.

There is still a need for improved methods and compositions for inhibiting microbial growth on dough-based products.

### SUMMARY OF THE INVENTION

The present invention is broadly concerned with an antimicrobial pan release agent comprising at least one essential oil dispersed or dissolved in a fat or oil-based carrier. Advantageously, the pan release agent remains stable for at least about 15 days under ambient conditions.

The invention is also concerned with a method of extending the shelf life of a dough- or batter-based product. The method comprises treating the surface of a dough or batter with an antimicrobial pan release agent comprising an essential oil dispersed or dissolved in a fat or oil-based carrier, and baking the dough or batter in a baking pan to yield a baked product having an extended mold-free shelf life.

The invention is also directed toward the combination of a dough- or batter-based baked product having an outer surface and a coating of antimicrobial pan release agent. The outer surface of the baked product comprises a pan-contacting surface and an exposed surface, and the coating of antimicrobial pan release agent is adjacent to the pan-contacting surface. The antimicrobial pan release agent comprises an essential oil dispersed or dissolved in a fat- or oil-based carrier.

The present invention is also directed to methods and the compositions for preparing long shelf life and/or extremely long shelf life edible dough- and batter-based products, such as bread and cake, by: (1) treating the surfaces of the dough or finished product with an improved antimicrobial oil-based composition, such as pan releasing oil, that contains at least one plant essential oil, such as cinnamon oil; and (2) introducing high doses of anti-staling maltogenic alpha-amylase and/or any other anti-staling enzymes and agents. This leads to improved flavor over the shelf life of the baked product, and the resulting products will have a longer mold-free shelf life, significantly reduced staling, improved flavor and taste, and will remain fresh and tasty for up to about 60 days.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. (FIG.) 1 is a graph of the average crumb firmness from the texture data gathered in Example 1;

FIG. 2 is a graph of the average crumb resilience from the texture data gathered in Example 1;

FIG. 3 is a graph of the average crumb adhesiveness from the texture data gathered in Example 1;

FIG. 4 is a color photograph demonstrating the stability of the pan release agent prepared in Example 2 after 76 days;

FIG. 5 is a graph of the shelf-life data from the cupcakes prepared in Example 3;

FIG. 6 is a graph of the shelf-life data from the bread prepared in Example 4 using different pan release formulations;

FIG. 7 is a graph of the shelf-life data from the bread prepared in Example 5 with or without 5% Caparve in the dough using different pan release agent formulations;

FIGS. 8(A)-(F) are color photographs taken at day 22 post-baking of bread loaves prepared in Example 6 using different pan release agent formulations;

FIG. 9 is a graph of the panelist test results for aroma from Example 7;

FIG. 10 is a graph of the panelist test results for softness from Example 7;

FIG. 11 is a graph of the panelist test results for taste from Example 7;

FIG. 12 is a graph of the overall preference of the panelists for the freshly baked bread compared to the inventive bread over time;

FIG. 13 is a graph of the texture analysis for average firmness from Example 7;

FIG. 14 is a graph of the texture analysis for average resilience from Example 7;

FIG. 15 is a graph of the texture analysis for average adhesiveness from Example 7;

FIG. 16 is a graph of the percentage of molded bread baked using various pan release agents from Example 8; and

FIGS. 17(A)-(F) are photographs of bread 11 days after being baked using various pan release agents: (A) Control; (B) 5% Cassia Oil; (C) 10% Cassia Oil; (D) 10% Clove Oil; (E) 10% Bay Leaf Oil; and (F) 10% Tea Tree Oil.

### DETAILED DESCRIPTION OF THE INVENTION

In more detail, the present invention is concerned with novel pan release agents as well as novel methods of making leavened (yeast or chemical) bakery products and other dough-based bakery products with these formulations, with yeast-raised dough products being particularly preferred. These dough-based products include those selected from the group consisting of breads, buns, rolls, English muffins, bagels, laminated doughs, pizza crust, pastries, tortillas, crumpets, and pretzels. The invention is also concerned with batter formulations and novel methods of making batter-based products such as cakes, cupcakes, muffins, quick breads, waffles, and pancakes.

In one method of the invention, the surface of a dough- or batter-based product is treated with the novel, antimicrobial pan release agent in accordance with the invention, which can be used in addition to, or in lieu of, chemical and/or natural preservatives in or on the dough or batter formulations. In general, pan release agents are compositions used to coat baking pan surfaces, such as baking pans, and allow for easy removal of the baked product without sticking to the bottom and/or sides of the baking pan. These release agents provide a film between the dough or batter and the surfaces of the baking pan facilitating release of the product after baking. In addition to facilitating the release of the baked product from the pan, the present pan release agent imparts a number of beneficial properties to the resulting baked product. Although the term “pan release agent” is used to describe the inventive compositions of the invention, it will be appreciated that the use of the composition is not limited to coating baking surfaces. Such additional uses will become apparent from the disclosure herein. Advantageously, the dough- and batter-based products of the invention have: 1) improved mold resistance by using either all-natural mold inhibition systems, or combinations of natural and chemical mold inhibition systems; 2) reduced staling when used with anti-staling enzymes; 3) improved flavor and taste; and 4) significantly extended overall shelf life.

The inventive pan release agent comprises an essential oil dispersed or dissolved (i.e., miscible) in a carrier. Alternatively, the pan release agent can consist (or consist essentially) of an essential oil dispersed or dissolved in the carrier. As used herein, the term “essential oil” refers to a volatile, liquid plant extract having the characteristic odor or flavor of the plant from which it was obtained. Suitable essential oils are any essential oils with antimicrobial activity, including those selected from the group consisting of cassia oil, cinnamon oil, clove oil, bay leaf oil, tea tree oil, rosemary oil, garlic oil, mustard oil, ginger oil, onion oil, thyme oil, mint oil, peppermint oil, and combinations thereof. The pan release agent preferably comprises from about 0.01% to about 75% by weight essential oil(s), more preferably from about 1% to about 50% by weight essential oils, even more preferably from about 2 to about 25% by weight essential oils, and most preferably from about 8% to about 15% by weight essential oils, based upon the total weight of the release agent taken as 100% by weight.

Preferred essential oils will not only inhibit microbial growth, but also impart a pleasant flavor to the resulting baked product. Cassia oil and cinnamon oil are particularly preferred essential oils for use in the present invention. Cassia oil (or Cinnamomum aromaticum) is different from cinnamon oil (or Cinnamomum verum) and contains more than 80% by weight cinnamaldehyde, although both can be used interchangeably in the pan release compositions. For example, in one embodiment, the antimicrobial pan release agent preferably comprises from about 1% to about 50% by weight cassia oil or cinnamon oil, more preferably from about 2% to about 20% by weight cassia oil or cinnamon oil, even more preferably from about 5% to about 10% by weight cassia oil or cinnamon oil, and most preferably from about 8% to about 10% by weight cassia oil or cinnamon oil, based upon the total weight of the release agent taken as 100% by weight. If rosemary is used as the essential oil, it is preferred, and more preferably required, that at least one other essential oil listed above also be present in the pan release oil. That is, rosemary, when present, is preferably not the only essential oil in the pan release agent. In another aspect of the invention, the pan release agent may comprise less than about 0.01% by weight rosemary oil, more preferably less than about 0.001% by weight rosemary oil, and even more preferably comprise about 0% by weight (i.e., be substantially free of) rosemary oil based upon the total weight of the pan release agent taken as 100% by weight.

Depending on the carrier used, the pan release agent can be in liquid or solid/semi-solid form. The liquid carrier will preferably have a Brookfield viscosity at ˜100° F. of from about 15 cP to about 100 cP, preferably from about 20 cP to about 95 cP, and even more preferably from about 30 cP to about 90 cP. The liquid carrier will also preferably have a smoke point of from about 225° F. to about 500° F., more preferably from about 310° F. to about 400° F., and even more preferably from about 320° F. to about 340° F. The solid/semi-solid carrier is preferably solid or semi-solid (i.e., a self-sustaining body) at room temperature (˜72° F.), and has a melting point of from about 80° F. to about 150° F., preferably from about 80° F. to about 145° F., and more preferably from about 110° F. to about 140° F. Suitable carriers are generally selected from the group consisting of traditional pan oils (vegetable and mineral oils), fats, and combinations thereof. Suitable fats include animal fat and vegetable oil, shortenings such as tallow, cottonseed oil, palm oil, canola oil, and soybean oil, or a combination thereof. More preferably, for the liquid pan release agent, the carrier preferably comprises (or consists essentially of) at least one ingredient or combination of ingredients selected from the list in Table 1 below.

TABLE 1
Liquid Carrier Ingredients

| | | | Most |
|---|---|---|---|
| Ingredient | Broad Range* | Preferred* | Preferred* |
| Vegetable Oil | 0-100% | 50-95% | 65-93% |
| Mineral Oil | 0-40% | 0.001-30% | 0.01-20% |
| Emulsifiers | 0-20% | 1-15% | 2-10% |
| Antioxidants | 0-3% | 0.01-1% | 0.05-0.5% |
| Petroleum Jelly | 0-10% | 0.001-8% | 0.01-5% |
| Phosphated Monoglycerides | 0-10% | 0.001-8% | 0.01-5% |
| Calcium Carbonate | 0-10% | 0.001-8% | 0.01-5% |
| Silica | 0-10% | 0.001-8% | 0.01-5% |

*Based upon the total weight of the carrier taken as 100% by weight. Although in the broad range, some of the ingredients can be omitted entirely from the composition (i.e., 0% by weight), the carrier contains at least one of the above ingredients. That is, the ingredients cannot be all 0% by weight at one time, and thus at least one of the ingredients will be present at a level greater than 0% at any given time.

In the solid/semi-solid pan release agent, the carrier preferably comprises (or consists essentially of) an ingredient or combination of ingredients selected from the list in Table 2 below.

TABLE 2
Solid/Semi-Solid Carrier Ingredients

| | | | Most |
|---|---|---|---|
| Ingredient | Broad Range* | Preferred* | Preferred* |
| Vegetable Oil | 0-100% | 30-80% | 40-60% |
| Animal Fat | 0-100% | 30-80% | 40-60% |
| Emulsifiers | 0-20% | 1-15% | 2-7% |
| Antioxidants | 0-3% | 0.01-1% | 0.05-0.5% |
| Grain Flour/Starch | 0-50% | 5-30% | 10-20% |

*Based upon the total weight of the carrier taken as 100% by weight. Although in the broad range, some of the ingredients can be omitted entirely from the composition (i.e., 0% by weight), the carrier contains at least one of the above ingredients. That is, the ingredients cannot be all 0% by weight at one time, and thus at least one of the ingredients will be present at a level greater than 0% at any given time.

Suitable vegetable oils for use in either pan release agent are selected from the group consisting of soy, corn, palm, coconut, sunflower, canola, safflower, peanut, rice bran oil, cottonseed, palm kernel, olive, sesame oil, linseed oil, rapeseed, and combinations thereof. The vegetable oils are preferably non- or partially-hydrogenated oils. In one aspect, the vegetable oil is used as the main or only carrier in the pan release agent. Thus, the pan release agent consists or consists essentially of at least one essential oil and vegetable oil.

Suitable emulsifiers for use in the carriers include lecithin, mono- and diglycerides, polysorbate 60, propylene glycol monoesters (PGME), and combinations thereof. When present, lecithin can be used at a broad range of from about 0.001 to about 20% by weight, while mono- and diglycerides, when present, are preferably used at a level of from about 0.001 to about 5% by weight. Suitable antioxidants include butylated hydroxytoluene (BHT), mixed tocopherols, rosemary extract, tert-butylhydroquinone (TBHQ), citric acid, and combinations thereof. Suitable grain flours or starches for use in the solid/semi-solid carrier include those selected from the group consisting of corn, wheat, rice, sorghum, rye, barley, and combinations thereof.

The antimicrobial effect of the pan release agent can be further enhanced using a chemical preservative in the release agent itself. Suitable chemical preservatives include those selected from the group consisting of sorbic acid, potassium sorbate, propionic acid, and calcium propionate. The chemical preservatives are preferably used at a range of from about 0 to about 2% by weight, more preferably from about 0.1 to about 1% by weight, and even more preferably from about 0.2 to about 0.5% by weight, based upon the total weight of the pan release agent taken as 100% by weight. In one aspect of the invention, the pan release agent comprises an essential oil and at least one chemical preservative dispersed or dissolved in a carrier.

The pan release agent can also comprise additional natural or artificial flavoring agents including those selected from the group consisting of vanilla, butter, apple, lemon, bread crust, strawberry, raisin, cranberry, maple, blueberry, and mixtures thereof.

In another aspect of the invention, the pan release agent may comprise less than about 2% by weight water, and preferably less than about 0.5% by weight water, based upon the total weight of the pan release agent taken as 100% by weight. More preferably, the pan release agent is free of any water. The pan release agent may also comprise less than about 100 ppm natamycin, preferably less than about 50 ppm, more preferably less than about 20 ppm natamycin, and even more preferably less than about 1 ppm natamycin. Most preferably, the pan release agent is free of any natamycin. The pan release agent may also comprise less than about 25 IU/g nisin, more preferably less than about 15 IU/g nisin, and even more preferably less than about 1 IU/g nisin, based upon the total weight of the pan release agent in grams. IU stands for international activity unit, which is conventionally used to measure nisin. Most preferably, the pan release agent is free of any nisin. The pan release agent may also comprise less than about 2% by weight alcohol (including glycerol), and preferably less than about 0.5% by weight alcohol, based upon the total weight of the pan release agent taken as 100% by weight. More preferably, the pan release agent is free of any alcohols (including glycerol). Thus, the pan release agent is preferably primarily oil- or fat-based. Finally, although mineral oil can be used in the carrier, in one aspect, the pan release agent may comprise less than about 2% by weight mineral oil, more preferably less than about 0.5% by weight mineral oil, and even more preferably be free of mineral oil, based upon the total weight of the pan release agent taken as 100% by weight.

The liquid pan release agent can be formed by blending the essential oil(s) and the carrier at room temperature (˜72° F.). In embodiments where a solid or semi-solid carrier is used, the carrier is preferably heated to about its melting point before blending in the essential oils. The pan release agent can then be re-solidified before use. Alternatively, the essential oil(s) can be added directly to the carrier ingredients during the manufacturing of the pan release agent. Regardless of the embodiment, the pan release agent advantageously remains stable over extended storage periods (e.g., at least about 15 days, preferably at least about 30 days, more preferably at least about 50 days, and even more preferably at least about 75 days) under ambient conditions (about 72° F. and about 40-75% relative humidity). The term “stable” as used herein refers to the lack of separation of the individual components (e.g., the essential oil from the carrier) over time, as well as to the oxidative stability of the carrier over time.

The pan release agent is preferably utilized to treat the surfaces of the dough, batter, or resulting baked product. The improved antimicrobial pan release agent may be applied to the surface of the dough, batter, or resulting products in any suitable manner, prior to or after depositing the dough or batter into the baking pan. The pan release agent is preferably utilized at an amount of from about 0.001% to about 2% by weight release agent, more preferably from about 0.1% to about 1% by weight pan release agent, and even more preferably from about 0.2% to about 0.5% by weight pan release agent, based upon the total weight of the treated product taken as 100% by weight. The antimicrobial pan release agent can be applied to the surfaces of the product that come into contact with the pan (i.e., the “pan-contacting” surfaces of the dough or batter), or to those surfaces of the product that do not come into contact with the pan, such as the crown of a bread loaf or cupcake (i.e., the “non-contacting” or “exposed” surfaces of the dough or batter), or a combination thereof. Preferably, the pan release agent coats at least about 10% of the surface area of the product, more preferably at least about 50% of the surface area of the product, even more preferably from about 75% to about 90% of the surface area of the product, and most preferably from about 90% to about 100% of the surface area of the product, based upon the total surface area of the product taken as 100%. The antimicrobial pan release agent can be applied to the product surfaces by any method suitable for coating the exterior surface of the product, including spraying, wiping, dipping, smearing, basting, brushing, enrobing, or any combination thereof. Preferably, the pan release agent is applied to the dough- or batter-contacting surfaces of the baking pan before adding the dough or batter, in which case the pan release agent is transferred to the pan-contacting surfaces of the dough or batter once added to the pan. For example, the antimicrobial pan release agent can be used to grease bread pans prior to adding the dough loaves. The non-contacting or exposed surfaces of the dough or batter can also be sprayed with the pan release agent after adding the dough or batter to the pan (e.g., in lieu of topical spraying with sorbate as in traditional methods). This can be carried out in conjunction with the application of the pan release agent to the pan. The pan release agent can also be applied to the pan-contacting and/or non-contact surfaces (i.e., crust) of the dough or batter product after baking, before or after removal from the pan, as applicable. The application of the pan release agent after baking can be by spraying or otherwise directly applying the pan release agent to the surfaces of the baked product, as described above.

Any of the foregoing application methods can be carried out alone, or in combination with another suitable method of preventing mold growth. For example, the pan release agent can be applied to the pan-contacting surfaces of the dough or batter as described above, followed by spraying the non-contact surfaces of the dough or batter with a chemical preservative, such as potassium sorbate, either before or after baking. The treatment of the surface of the dough or batter described herein may also be used in combination with the addition of natural or chemical preservatives inside the dough or batter, as discussed in more detail below. In one embodiment, the present invention relates to the method of producing dough- or batter-based products with only natural preservatives by treating the surface of dough or batter with the improved pan release agent comprising the carrier and the essential oil(s), and adding natural preservatives inside the dough or batter formulation. The treatment of the surface of the dough or batter described herein may also be used in combination with the addition of chemical preservatives inside the dough or batter to maximize the antimicrobial effects and to extend the mold-free shelf life of the resulting baked product. However, the inventive pan release agent can also be used with doughs or batters formulated without chemical-based preservatives or without any preservatives or other antimicrobial agents at all. Thus, in one aspect of the invention, although the surface of the product is treated with the essential oils in the pan release agent, the dough or batter formulations themselves preferably comprise less than about 5% by weight essential oils inside the dough or batter formulation, more preferably less than about 2% by weight essential oils, and even more preferably are free of any essential oils inside the dough or batter formulation, based upon the total weight of the formulation taken as 100% by weight. In some embodiments of the invention, the pan release agent also comprises less than about 2% by weight chemical preservatives, and preferably less than about 1% by weight chemical preservatives. More preferably, the pan release agent is free of any chemical preservatives. Likewise, the pan release agent can comprise less than about 2% by weight other natural preservatives, and preferably less than about 1% by weight other natural preservatives. More preferably, the pan release agent is free of any other natural preservatives. In this way, the disadvantages of the traditional preservatives in the dough or batter are avoided, while still providing a natural dough- or batter-based product with extended shelf-life and improved flavor.

Thus, although the antimicrobial effectiveness can be greatly enhanced by the combinations of surface treatments of the dough- or batter-based products and the addition of natural or chemical preservatives inside the dough or batter, the present invention is preferably used to reduce or even eliminate the need of preservatives or other antimicrobial agents added inside or on top of the dough or batter. By reducing or eliminating the preservatives inside the dough or hatter, it can reduce or avoid many problems associated with the preservatives inside the dough or batter, such as yeast inhibition, off-flavors, and other negative impacts on the color and the texture of the final products. Accordingly, in some embodiments, the essential oil in the pan release agent is the only antimicrobial agent used to extend the shelf-life of the dough- or batter-based products. That is, the pan release agent and/or the dough or batter formulations themselves are preferably substantially free of any other antimicrobial agent, and more specifically comprise less than about 2% by weight of other antimicrobial agent, more preferably less than about 1% by weight of other antimicrobial agent, based upon the total weight of the pan release agent or baked product taken as 100% by weight, as applicable. The term “antimicrobial,” as used herein, refers to any agent that kills or inhibits the growth of bacteria, fungi, or protozoans. Thus, the term “other antimicrobial agent,” as used herein, refers to any other antimicrobial agents besides the essential oil in the pan release agent of the invention.

With the combination of the present invention described herein and the anti-staling methods and compositions, dough- and batter-based products, such as bread and cake, can be prepared and maintained free from mold growth and from undesirable staling for extended storage periods. More specifically, the baked products will have a mold-free shelf life of at least about 20 days, more preferably at least about 30 days, and even more preferably at least about 60 days under ambient conditions (˜72° F. and 40-75% relative humidity). As used herein, the term “mold free” means that there is no mold growth on the surface of the treated food product visible to the naked eye (i.e., unaided by magnification). The significant shelf life extension of such dough- and batter-based products can help increase the production efficiency (by producing large numbers of products in a longer production run and by storing away the product without loss of product quality), to expand the distribution network and market size, and to reduce the waste of the final products both in retail stores and in the consumer's home.

Advantageously, many of the essential oils used in the invention also have a strong and pleasant flavor. When used in appropriate concentration, and/or in combination with other flavor compositions, they can enhance the flavor of the final products, and compensate for the loss of flavor from the product itself during its shelf life.

The inventive pan release agent is suitable for use with any dough- or batter-based products. However, in a preferred method of making dough- and batter-based products having an extended shelf-life, a plurality of ingredients for the leavened dough-based product or batter-based products are mixed together. These ingredients and their preferred ranges are set forth in Tables 3 and 4.

TABLE 3
Ingredients for Dough-Based Products

| | | | Most |
|---|---|---|---|
| Ingredient | Broad Range* | Preferred* | Preferred* |
| Leavening agent | 1-10% | 2-6% | 2-4% |
| Dough Conditioner | 0-10% | 0.2-5% | 0.3-3% |
| Water | 30-90% | 45-80% | 50-70% |
| Non-Fat Dry Milk | 0-5% | 0.001-3% | 0.01-2% |
| Salt | 0-4% | 1-3% | 1.5-2% |
| Sugar | 0-55% | 4-20% | 6-15% |
| Oil/Fat | 0-10% | 1-5% | 2-3% |
| Mono- and Diglycerides | 0-5% | 0-3% | 0.5-2% |

*Baker's percentage (100% flour).

TABLE 4
Ingredients for Batter-Based Products

| | | | Most |
|---|---|---|---|
| Ingredient | Broad Range* | Preferred* | Preferred* |
| Eggs (Liquid) | 0-80% | 40-75% | 50-70% |
| Oil/Fat | 0-50% | 15-40% | 20-30% |
| Water | 50-100% | 60-90% | 65-85% |
| Sugar | 0-150% | 60-130% | 100-120% |
| Yogurt | 0-20% | 2-10% | 3-8% |
| Modified Food Starch | 0-20% | 2-10% | 3-8% |
| Salt | 0-5% | 1-4% | 2-3% |
| Leavening agent | 1-10% | 2-8% | 3-6% |
| Buttermilk | 0-5% | 0-3% | 0.001-2% |
| Gums | 0-5% | 0.1-3% | 0.2-2% |
| Whey | 0-10% | 0-6% | 0.001-3% |
| Wheat Gluten | 0-10% | 0-5% | 0.001-3% |
| Sodium Caseinate | 0-5% | 0-3% | 0-2% |
| Emulsifiers | 0-20% | 0.5-10% | 1-5% |

*Baker's percentage (100% flour).

The term “baker's percentage,” as used herein, refers to the amount by weight of an ingredient in the formulation expressed as a percentage of the total flour weight (which is always 100%). Suitable flours for use in the dough- and batter-based formulations include enriched bleached flour, all-purpose flour, whole wheat flour, pastry flour, bread flour, white wheat flour, cake flour, rye flour, and mixtures thereof.

Suitable leavening agents include yeast, sodium bicarbonate, potassium bicarbonate, sodium aluminum phosphate, sodium acid pyrophosphate, sodium aluminum sulfate, monocalcium phosphate, any other leavening acids, and combinations thereof. Yeast is the preferred leavening agent for the dough formulations and can be any yeast conventionally used in yeast-raised bakery products, with compressed yeast being preferred.

The term “dough conditioner,” as used herein, is intended to refer to additives that affect the condition (handling characteristics, machinability) of the dough, as well as those that actually strengthen the dough by increasing its resistance to mechanical stress. Suitable chemical dough conditioners include those selected from the group consisting of sodium stearoyl lactylate (SSL), metabisulfite, calcium stearoyl lactylate (CSL), diacetyl tartaric acid esters of mono-diglycerides (DATEM), ethoxylated monoglycerides, potassium bromate, potassium iodate, azodicarbonamide (ADA), calcium peroxide, potassium sorbate, sorbic acids, and L-cysteine. Suitable natural dough conditioners include those selected from the group consisting of ascorbic acid, enzyme active soy flour, amylases (fungal), xylanases, hemicellulases, proteases, glucose oxidases, hexose oxidases, peroxidases, lipases, phospholipases, transglutaminases, and cellulases. A preferred dough conditioner is sold under the name DEPENDOX® AXC (a blend of ascorbic acid, ADA, fungal enzymes, and wheat starch; available from Caravan Ingredients).

The sugar can be any typical sugar used in bakery products, including granulated brown or white sugar, high fructose corn syrup, corn syrup, fructose, invert sugar, honey, molasses, maple syrup, and mixtures thereof.

The preferred oil or fat is selected from the group consisting of soy oil, partially hydrogenated soy oil, lard, palm oil, corn oil, cottonseed oil, canola oil, vegetable shortening, and mixtures thereof.

Suitable emulsifiers for use in the batter formulations include those selected from the group consisting of polysorbate 60, PGME, mono-diglycerides, lecithin, sorbitan monostearate, polyglycerol esters, sucrose esters, SSL, and mixtures thereof.

Preferred gums for using the formulations include those selected from the group consisting of xathan, guar, cellulose, arabic, carrageenan, alginate, and combinations thereof.

The dough compositions also preferably include anti-staling amylase. Preferred anti-staling amylases are maltogenic amylases, such as maltogenic α-amylase, G-4 amylase, and thermally-stable bacterial amylase. Even more preferably, the anti-staling amylase is a maltogenic exoamylase, such as those sold under the name NOVAMYL® 10,000 by Novozymes A/S, as described in U.S. Patent Application Pub. No. 2009/0297659, incorporated by reference herein in its entirety. When present, NOVAMYL® 10,000 is used at activity levels of from about 0.001-40,000 MANU/kg of flour, more preferably from about 5,000 to about 30,000 MANU/kg of flour, and even more preferably from about 5,000 to about 10,000 MANU/kg of flour. As used herein, one MANU (Maltogenic Amylase Novo Unit) is defined as the amount of enzyme required to release one μmol of maltose per minute at a concentration of 10 mg of maltotriose (Sigma M 8378) substrate per ml of 0.1 M citrate buffer, pH 5.0 at 37° C. for 30 minutes. Use of the maltogenic amylase at these high levels results in many significant advantages, as described in U.S. Patent Application Pub. No. 2009/0297659. For example, utilizing the maltogenic amylase at high levels may allow for the quantity of other ingredients commonly usedin the industry to be reduced. That is, the following formula changes might be made: decreased sugar, increased water, decreased yeast, reduced dough conditioners.

The dough formulations can also include other enzymes in addition to, or in lieu of, the anti-staling amylase. Such other enzymes include those selected from the group consisting of asparaginase, lactase, amyloglucosidase, pullulanse, and combinations thereof.

The dough or batter formulations can also include preservatives. Suitable preservatives for use in the dough formulations include natural and chemical preservatives. Preferred natural preservatives for use in the dough or batter formulations include those selected from the group consisting of vinegar, raisin juice concentrate, fermented whey, fermented flour, fermented starch, and fermented sugars. Preferred chemical-based preservatives for use in the dough or batter formulations include those selected from the group consisting of sorbic acid, potassium sorbate, propionic acid, sorbyl-palmitate, sodium propionate, benzoates, methyl and propyl paraben, and calcium propionate. As described above, the preservatives can be included in the dough or batter formulation itself, and/or applied to the outside of the dough or baked product once formed. The preservatives can also be used in encapsulated form. When present in the formulations, the dough or batter formulations will include preservatives in an amount of from about 0.001 baker's % to about 2 baker's %, more preferably from about 0.1 baker's % to about 1.5 baker's %, and most preferably from about 0.2 baker's % to about 1 baker's %.

The dough or batter formulations can also include additives such as artificial flavors, spices, and colorings.

In forming the dough-based products according to the invention, the ingredients listed in Table 3 above can be simply mixed together in one stage using the “no-time dough process,” or they can be subjected to the “sponge and dough process.” In the latter process, part of the flour (e.g., 55-75% by weight of the total flour) is mixed with water, yeast, and preferably some of the dough conditioner (if utilized) and allowed to ferment for a time period of from about 3 hours to about 4 hours at from about 70° F. to about 90° F. and from about 80% to about 90% relative humidity. This forms the “sponge.” After this time period, the remaining ingredients are mixed with the sponge for a time period of from about 2 minutes to about 20 minutes.

The maltogenic amylase can be provided as part of a “pre-mix” product that can be conveniently mixed with the sponge dough, as described in U.S. Patent Application Pub. No. 2009/0297659. A preferred such pre-mix comprises the maltogenic amylase, a diluent, a density-adjusting component, and a fat or oil. The amylase is preferably provided in the pre-mix at a level of from about 2% to about 10% by weight, and more preferably from about 4% to about 8% by weight, based upon the total weight of the pre-mix taken as 100% by weight. The diluent is provided at levels of from about 60% to about 80% by weight, and more preferably from about 70% to about 80% by weight, based upon the total weight of the pre-mix taken as 100% by weight. Examples of suitable diluents include those selected from the group consisting of flour (e.g., wheat flour), starches, powdered emulsifiers, salt, sugar, flow agents, and mixtures thereof. The density-adjusting component is provided at levels of from about 15% to about 95% by weight, and more preferably from about 20% to about 28% by weight, based upon the total weight of the pre-mix taken as 100% by weight. Examples of suitable density-adjusting components include those selected from the group consisting of calcium sulfate, salt, sugar, and mixtures thereof. The fat or oil is provided at levels of from about 0.01% to about 3% by weight, and more preferably from about 0.08% to about 1.5% by weight, based upon the total weight of the pre-mix taken as 100% by weight. Examples of suitable fats and oils include those selected from the group consisting of vegetable oils (e.g., soybean oil), mineral oil, sunflower oil, cottonseed oil, and mixtures thereof.

Regardless of whether the remaining ingredients are mixed with the sponge individually or with the use of a pre-mix, the mixed dough is preferably allowed to rest for a time period of from about 5 minutes to about 15 minutes before being divided and formed into the desired size pieces and placed in the baking pans greased with the pan release agent. The dough is then preferably allowed to proof at a temperature of from about 95° F. to about 105° F. at a relative humidity of from about 75% to about 95% for a time period of from about 50 minutes to about 70 minutes. The product can then be baked using the times and temperatures necessary for the type of product being made (e.g., from about 400° F. to about 440° F. for about 15 minutes to about 30 minutes).

To prepare the batter-based products, all of the ingredients from Table 4 above are simply mixed together to form a batter. The batter is then poured into the selected baking pan greased with the pan release agent and baked using the times and temperatures necessary for the type of product being made (e.g., from about 350° F. to about 380° F. for about 25 minutes to about 35 minutes).

In both embodiments, as noted above, the inventive pan release agent is applied to the pan-contacting surfaces of the dough or batter, for example, by coating the product-contacting surfaces of the selected baking pan prior to adding the dough or batter. The pan release agent can also be applied to the non-contact surfaces of the dough or batter (i.e., the top and/or sides) by any suitable method as described. This can be done before or after baking. After baking, the resulting baked product is removed from the pan and packaged for distribution or sale.

Bakery products formed according to the present invention have improved “freshness” shelf life, which includes improved softness (reduced firmness) and resilience, and acceptable adhesiveness, along with greatly improved mold-free shelf life. While mold-free shelf life can be evaluated with the naked eye for visible mold growth on the surface of the product, the freshness shelf life can be evaluated using objective texture analysis, such as by using a Texture Analyzer (e.g., TA.XTPlus; Texture Technologies Corp.; Scarsdale, N.Y.).

### EXAMPLES

The following examples set forth methods in accordance with the invention. It is to be understood, however, that these examples are provided by way of illustration and nothing therein should be taken as a limitation upon the overall scope of the invention.

### Example 1

### White Pan Bread Formulation with Inventive Pan Release Agent

In this procedure, a standard straight dough white pan bread formulation was prepared according to the following dough bread making process, using the ingredients in Table 5, below.

TABLE 5
Straight Dough White Bread Formula

| INGREDIENTS | Baker's % | Grams |
|---|---|---|
| Flour | 100 | 3000 |
| Compressed Yeast | 4 | 75 |
| Sodium Stearoyl Lactylate (SSL) | 0.5 | 15 |
| Ice Water | 60 | 1800 |
| Non-fat dry milk (NFDM) | 1.0 | 30 |
| Salt | 2.0 | 60 |
| Sugar | 8.0 | 240 |
| Calcium Propionate | 0.50 | 15 |
| NOVAMYL ® 10,000 | 0.1^{A} | 3 |
| DEPENDOX ® AXC^{B} | 0.04 | 1.2 |
| GMS 90 SS^{C} | 2.00 | 60 |
| Soy Oil | 2 | 60 |

^{A}In some of the loaves, NOVAMYL ® 10,000 was used at 1,000 ppm, while 100 ppm NOVAMYL ® 10,000 was used in others.
^{B}A blend of ascorbic acid, azodicarbonamide (ADA), fungal enzymes, and wheat starch (available from Caravan Ingredients).
^{C}Hydrated monoglycerides (emulsifier; available from Caravan Ingredients).

All of the ingredients except for the salt were added to a 20 qt Hobart mixer, and mixed with a spiral hook on the 1st speed setting (low) for two minutes. The sides of the mixing bowl were scraped, and the ingredients were mixed for 7 minutes at the 2nd speed setting (high). The salt was added, followed by mixing at the 2nd speed setting for an additional 3 minutes until full dough development. The dough was allowed to rest on a wood bench for 10 minutes, and then divided into 525-gram dough pieces. The dough pieces were rounded, and then allowed to rest for 5 minutes. Next, a Gemini Straight Grain Moulder was used, according to the settings in Table 6 below, to sheet and mould the dough pieces, which were then placed into 1-lb loaf pans.

TABLE 6
Gemini Straight Grain Moulder Settings

| | |
|---|---|
| Rollers | 5/3 |
| Pressure Bd. | 32/31 |
| Guide Rails | 16/14 |

Prior to adding the dough, the loaf pans were coated with standard pan release oil, or an inventive pan release agent formulated according to Table 7, below.

TABLE 7
Pan Release Agent

| 10% Cassia Oil/SpraFilm Release | grains |
|---|---|
| Cassia oil | 50 |
| SpraFilm^{A} | 450 |
| Total | 500 |

^{A}All-vegetable, sprayable, bread pan release agent from Caravan Ingredients, Inc.

To make the inventive release agent, the ingredients were added to a 700 mL glass beaker with a stir bar and mixed for 5 minutes at 72° F. The amount of oil or release agent used in each pan is shown in Table 8, below.

TABLE 8

| | Pan Weight | Pan + Oil | Oil Weight |
|---|---|---|---|
| | (g) | (g) | (g) |
| Loaf 1.1 | 535.94 | 538.2 | 2.26 |
| Loaf 1.2 | 490.52 | 492.72 | 2.2 |
| Loaf 1.3 | 480.53 | 482.71 | 2.18 |
| Loaf 1.4 | 478.22 | 480.9 | 2.68 |
| Loaf 1.5 | 527.36 | 530.02 | 2.66 |
| Loaf 1.6 | 487.44 | 490.52 | 3.08 |
| Loaf 1.7 | 499.52 | 502.12 | 2.6 |
| Loaf 1.8 | 525.54 | 528.11 | 2.57 |
| Loaf 1.9 | 495.28 | 497.91 | 2.63 |
| Loaf 1.10 | 488.1 | 490.85 | 2.75 |
| Loaf 2.1 | 521.74 | 524.07 | 2.33 |
| Loaf 2.2 | 533.27 | 536.68 | 3.41 |
| Loaf 2.3 | 525.41 | 529.08 | 3.67 |
| Loaf 2.4 | 528.41 | 532 | 3.59 |
| Loaf 2.5 | 522.77 | 526.21 | 3.44 |
| Loaf 2.6 | 490.92 | 494.45 | 3.53 |
| Loaf 2.7 | 492.74 | 495.89 | 3.15 |
| Loaf 2.8 | 525.97 | 529 | 3.03 |
| Loaf 2.9 | 499.35 | 502.64 | 3.29 |
| Loaf 2.10 | 494.67 | 497.75 | 3.08 |
| Loaf 3.1 | 534.34 | 537.07 | 2.73 |
| Loaf 3.2 | 523.12 | 525.88 | 2.76 |
| Loaf 3.3 | 527.16 | 529.69 | 2.53 |
| Loaf 3.4 | 492.99 | 496.01 | 3.02 |
| Loaf 3.5 | 488.85 | 491.88 | 3.03 |
| Loaf 3.6 | 527 | 530.24 | 3.24 |
| Loaf 3.7 | 525 | 528.04 | 3.04 |
| Loaf 3.8 | 495.83 | 498.53 | 2.7 |
| Loaf 3.9 | 498.11 | 500.65 | 2.54 |
| Loaf 3.10 | 491.73 | 494.66 | 2.93 |

Ten loaves were prepared for each sample. Loaves 1.1-1.10 were Standard Pan Release/1000 ppm NOVAMYL® 10,000 loaves; loaves 2.1-2.10 were 10% Cassia Oil Pan Release/1000 ppm NOVAMYL® 10,000 loaves; and loaves 3.1-3.10 were 10% Cassia Oil Pan Release/100 ppm NOVAMYL® 10,000 loaves. The loaves were then proofed at 104° F. and 86% humidity for 80 minutes. The loaves were removed from the proof box and sprayed with a 10% sorbate solution, followed by baking at 420° F. for 20 minutes. After baking, the loaves were removed from the oven and depanned. The loaves were cooled on a cooling rack for 50 minutes, and then placed in poly bags with twist ties and stored at room temperature to observe mold growth.

Texture analysis was performed using a TA.XTPlus Texture Analyser (Texture Technologies Corp.; Scarsdale, N.Y.) on days 3, 9, 21, 35, 50, and 62 of testing to determine firmness, resilience, and adhesiveness. The Texture Analyser was set according to the following settings in Table 9.

TABLE 9
TA.XTPlus Settings

| Pre-Test Speed | 5 | mm/sec | Speed | Probe Speed while searching |
|---|---|---|---|---|
| | | | | for the trigger point |
| Test Speed | 1 | mm/sec | Speed | Speed of approach to target |
| | | | | distance (after triggering) |
| Post-Test Speed | 5 | mm/sec | Speed | Speed at which the probe |
| | | | | returns to the start point |
| | | | | after second cycle |
| Target Mode | 1 = Stain | | List | |
| Strain | 25% | | Strain | |
| 2nd Strain | 50% | | Strain | 2nd target strain distance |
| Time | 3 | sec | Time | Pause time between |
| | | | | compression cycles |
| Hold time on | 5 | sec | Time | |
| 2nd compression | | | | |
| Trigger Type | 0 = auto | | List | How the initiation of |
| | (force) | | | data capture is defined |
| Trigger Force | 5 | g | Force | Amount of force for the |
| | | | | TA to initiate data capture |

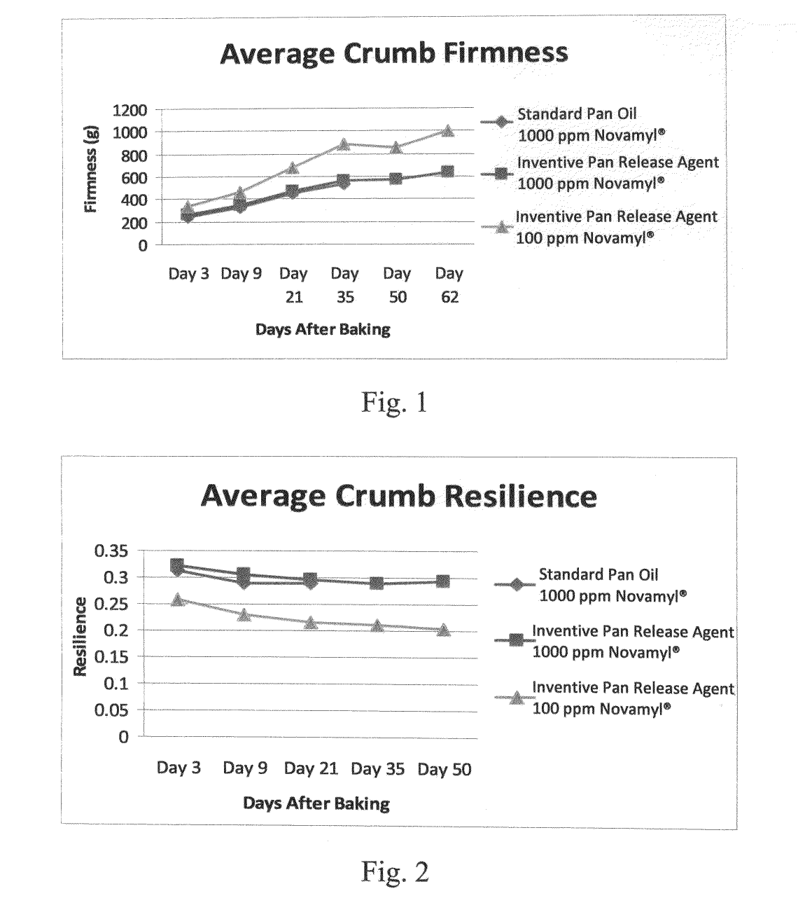

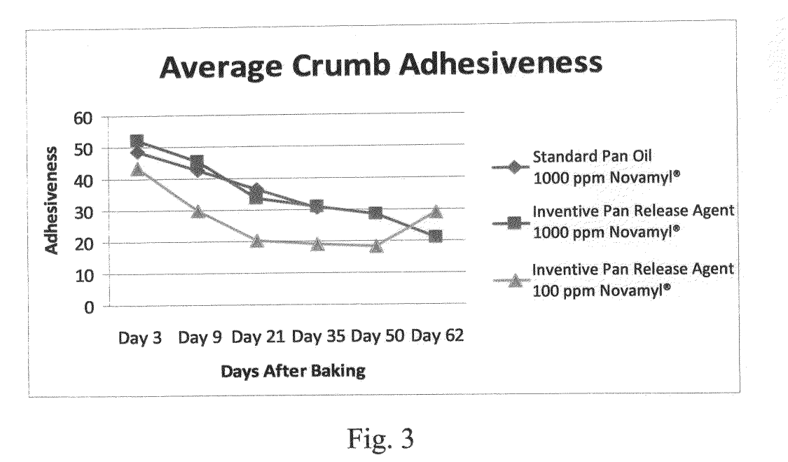

For the Texture Analysis, loaves of bread were sliced to a thickness of 0.5 inches. Eight sets of two slices from each loaf (excluding the two external slices, i.e., heels) were analyzed. The procedure for measuring the bread was to lay a pair of slices aligned on on top of the other on the platform of the Texture Analyzer, position it so the probe was approximately in the center of the stacked slices and about 10 mm above the surface of the top slice, and start the test program. The test generated a graph that was used to quantify the characteristics of the bread. The firmness was calculated as the peak force from the first compression. Resilience was calculated from the first compression as the area under the curve after the peak, divided by the area under the curve before the peak. Adhesiveness was calculated from the second compression as the negative area under the curve as the probe returned to the starting position. The results of the texture analyses are shown in Table 10, below and in FIGS. 1-3.

TABLE 10
Texture Data

| | Day 3 | Day 9 | Day 21 | Day 35 | Day 50 | Day 62 |
|---|---|---|---|---|---|---|
| | Firmness | | | | | |
| Standard Pan | 240 | 318 | 448 | 525 | x | x |
| Oil 1000 ppm | | | | | | |
| NOVAMYL ® | | | | | | |
| Inventive Pan | 262 | 343 | 470 | 558 | 569 | 634 |
| Release Agent | | | | | | |
| 1000 ppm | | | | | | |
| NOVAMYL ® | | | | | | |
| Inventive Pan | 330 | 456 | 672 | 881 | 850 | 998 |
| Release Agent | | | | | | |
| 100 ppm | | | | | | |
| Novamyl | | | | | | |
| | Resilience | | | | | |
| Standard Pan | 0.338 | 0.312 | 0.287 | 0.287 | x | x |
| Oil 1000 ppm | | | | | | |
| NOVAMYL ® | | | | | | |
| Inventive Pan | 0.346 | 0.321 | 0.305 | 0.295 | 0.288 | 0.294 |
| Release Agent | | | | | | |
| 1000 ppm | | | | | | |
| NOVAMYL ® | | | | | | |
| Inventive Pan | 0.295 | 0.257 | 0.229 | 0.214 | 0.21 | 0.203 |
| Release Agent | | | | | | |
| 100 ppm | | | | | | |
| NOVAMYL ® | | | | | | |
| | Adhesiveness | | | | | |
| Standard Pan | 49 | 42 | 36 | 30 | x | x |
| Oil 1000 ppm | | | | | | |
| NOVAMYL ® | | | | | | |
| Inventive Pan | 52 | 45 | 34 | 31 | 29 | 21 |
| Release Agent | | | | | | |
| 1000 ppm | | | | | | |
| NOVAMYL ® | | | | | | |
| Inventive Pan | 43 | 30 | 20 | 19 | 18 | 28.9* |
| Release Agent | | | | | | |
| 100 ppm | | | | | | |
| NOVAMYL ® | | | | | | |

*Bread cracked drastically during compression of the slices distorting adhesiveness values.
“x” denotes that texture data was not taken due to mold growth.

This Example demonstrates that the inventive pan release agent made it possible to store bread at room temperature for 60 days without mold growth, while the NOVAMYL® maintained the softness of the bread over time. The bread baked using only the Standard Pan Oil began to mold 27 days after baking, while the samples baked with the 10% Cassia Pan Release Agent did not mold after more than 60 days.

### Example 2

### Stability of Liquid Pan Release Agent

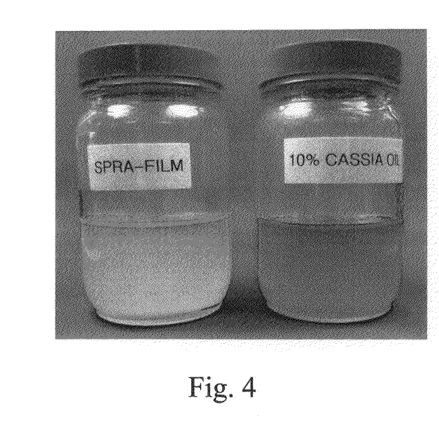

In this procedure, an inventive pan release agent was prepared, and then allowed to sit to test the stability of the pan release agent for extended storage periods. The pan release agent was prepared by mixing 50 grams of Cassia oil with 450 grams of Sprafilm (Caravan Ingredients, Inc.; Lenexa, Kans.) in a 700 mL glass beaker, equipped with a stir bar. The ingredients were mixed for 5 minutes until a homogenous mixture was formed. The oil and SpraFilm were at 72° F. before mixing. The resulting mixture was then transferred to a glass jar, capped with a lid, and allowed to sit under ambient conditions (72° F.). A jar of SpraFilm was used as a control. After 76 days, a photograph of the two jars was taken (FIG. 4). It can be seen that the inventive pan release agent is stable and there is no separation of the ingredients after 76 days. This is an improvement over existing mold inhibiting agents, that will fall out of solution in traditional pan release oils.

### Example 3

### Cupcakes Prepared with Inventive Solid Pan Release Agent

In this procedure, yellow cupcakes were prepared using the ingredients in Table 11 below, and then baked using an inventive pan release agent.

TABLE 11
Batter-based formulation

| | Grams |
|---|---|
| Yogurt Cake Base^{A} | 640 |
| Eggs (Liquid) | 224 |
| Soy Oil | 192 |
| Water | 144 |
| Total | 1200 |

^{A}Granulated Sugar, Enriched Bleached Flour, Vegetable Shortening, Food Starch- Modified, Cultured Yogurt, Sodium Bicarbonate, Sodium Aluminum Phosphate, Salt, Wheat Gluten, Whey, Sodium Steroyl Lactylate, Mono-Diglycerides, Xanthan Gum, Guar Gum, Cellulose Gum, Gum Arabic, Carrageenan, Buttermilk, Artificial Flavor, Sodium Caseinate, Spice, and Coloring (available from Caravan Ingredients).

To prepare the batter, the cake base and eggs were added to a 5 qt. Hobart mixer with a paddle attachment, and mixed on the 1st speed (low) for 1 minute, and then on the 2nd speed (high) for 3 minutes. While mixing on low for 1 minute, the soy oil and water were then added. The sides of the bowl and paddle were scraped with a rubber spatula, and then the batter was mixed for an additional 3 minutes on low. The batter was scaled to 40 g into cupcake pans that had been greased by brushing with either standard SpraShort cake release compound (from Caravan Ingredients, Inc.), or one of the inventive Cassia Oil/SpraShort release agents, formulated according to the ingredients in Table 12, below. The cupcakes were baked at 350° F. for 12 minutes. After baking, the cupcakes were cooled on a cooling rack for 15 minutes, and then individually bagged in Ziploc® bags. The cupcakes were stored at room temperature (˜72° F.) and observed for mold growth. After 28 days at room temperature, the cupcakes were moved to a hotbox at 80° F. to accelerate the shelf-life study.

TABLE 12
Inventive Pan Release Agents
5% Cassia Oil/SpraShort

| | |
|---|---|
| Cassia Oil | 15 g |
| SpraShort | 285 g |
| Total | 300 g |

10% Cassial Oil/SpraShort

| | |
|---|---|
| Cassia Oil | 30 g |
| SpraShort | 270 g |
| Total | 300 g |

To prepare the pan release agent, the SpraShort was melted to 145° F. in a 700 mL glass beaker while stirring with stir bar. The Cassia oil was added to the beaker and mixed to combine. While stirring, the mixture was cooled in an ice bath to 75° F., and then used to grease the cupcake pans.

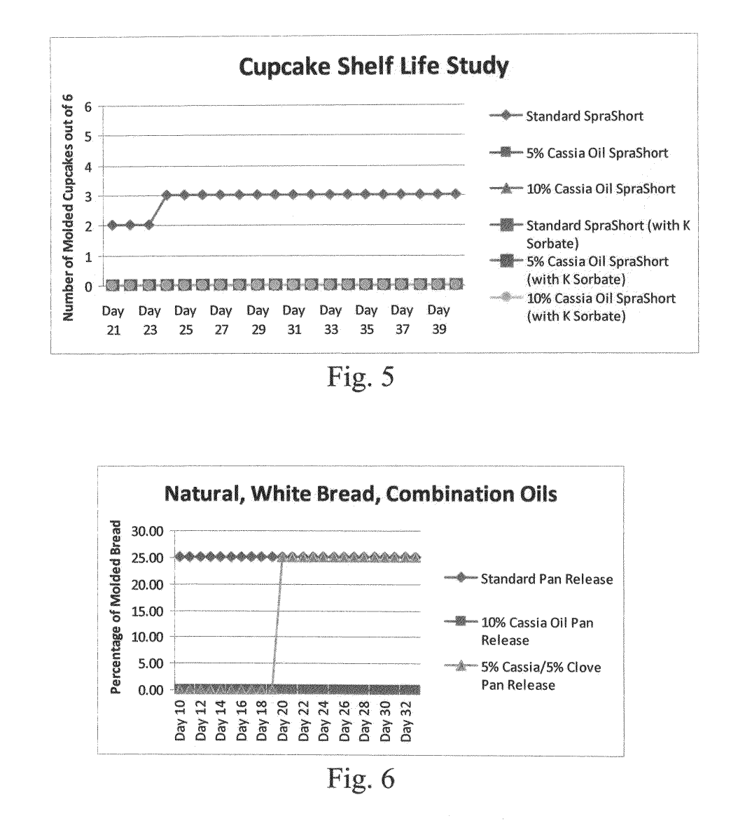

Mold was observed on all of the control cupcakes that were baked using the standard SpraShort release agent after 21 days. Cupcakes baked with the 5% and 10% Cassia oil/SpraShort release agent remained mold free for more than 40 days. The results are provided in FIG. 5, and in Table 13 below, which shows the number of cupcakes out of a total of 6 for each test that showed mold on the indicated day of testing.

TABLE 13
Results
No Internal Preservative

| | Standard | 5% Cassia Oil | 10% Cassia Oil |
|---|---|---|---|
| Day | SpraShort | SpraShort | SpraShort |
| Day 21 | 2 | 0 | 0 |
| Day 22 | 2 | 0 | 0 |
| Day 23 | 2 | 0 | 0 |
| Day 24 | 3 | 0 | 0 |
| Day 25 | 3 | 0 | 0 |
| Day 26 | 3 | 0 | 0 |
| Day 27 | 3 | 0 | 0 |
| Day 28 | 3 | 0 | 0 |
| Day 29 | 3 | 0 | 0 |
| Day 30 | 3 | 0 | 0 |
| Day 31 | 3 | 0 | 0 |
| Day 32 | 3 | 0 | 0 |
| Day 33 | 3 | 0 | 0 |
| Day 34 | 3 | 0 | 0 |
| Day 35 | 3 | 0 | 0 |
| Day 36 | 3 | 0 | 0 |
| Day 37 | 3 | 0 | 0 |
| Day 38 | 3 | 0 | 0 |
| Day 39 | 3 | 0 | 0 |
| Day 40 | 3 | 0 | 0 |

### Example 4

### White Bread with Inventive Pan Release Agent

In this procedure, a standard straight dough white pan bread formulation was prepared according to the following dough bread making process, using the ingredients in Table 14, below.

TABLE 14
Straight Dough White Bread Formula

| INGREDIENTS | Bakers % | Grams |
|---|---|---|
| Flour | 100 | 2000 |
| Instant Yeast | 2.5 | 50 |
| SSL | 0.5 | 10 |
| Ice Water | 60 | 1200 |
| NFDM | 1.0 | 20 |
| Salt | 2.0 | 40 |
| Sugar | 8.0 | 160 |
| Calcium Propionate | 0.30 | 6 |
| NOVAMYL ® 10,000 | 0.01 | 0.2 |
| DEPENDOX ® AXC^{A} | 0.04 | 0.8 |
| Soy Oil | 2 | 40 |

^{A}A blend of ascorbic acid, ADA, fungal enzymes, and wheat starch (available from Caravan Ingredients, Inc.).

The dough was prepared by mixing all ingredients in a McDuffy mixing bowl using a Hobart mixer on the 1st speed (low) for 1 minute. The sides of the bowl were then scraped with a rubber spatula, followed by mixing for 9 minutes at the 2nd speed (high) until the dough reached optimum development. The dough was allowed to rest on a wood bench for 10 minutes, and then divided into 170-gram dough pieces. The pieces were rounded and then allowed to rest for 5 minutes. Next, a Gemini Straight Grain Moulder was used on the settings outlined in Table 15 below to sheet and mould the dough.

TABLE 15
Gemini Straight Grain Moulder Settings

| | |
|---|---|
| Rollers | 2/1 |
| Pressure Bd. | 32/30 |

The dough was then placed into pup loaf pans (11.5 cm l.×6.5 cm w.×6 cm h.) and proofed at 104° F. and 86% humidity for 70 minutes. The pans had been greased with standard pan release oil (SpraFilm, available from Caravan Ingredients, Inc.), an inventive 10% cassia oil pan release agent, or an inventive 5% cassia oil/5% clove oil pan release agent. The average weight of the pan release agent or pan oil used in the pans was 1.27 grams. The formulation of each release agent is provided in Table 16, below.

TABLE 16
Pan Release Agents
10% Cassia Oil/SpraFilm

| | |
|---|---|
| Cassia Oil | 50 g |
| SpraFilm | 450 g |
| Total | 500 g |

5% Cassia Oil/5% Clove Oil/SpraFilm

| | |
|---|---|
| Cassia Oil | 25 g |
| SpraFilm | 475 g |
| Clove Oil | 25 g |
| Total | 500 g |

To prepare the pan release agents, the ingredients were added to a 700 mL glass beaker and mixed using a stir bar for 5 minutes until a homogenous mixture was formed. All of the ingredients were at 72° F.

Next, the loaves were proofed at 104° F. and 86% humidity for 1 hour. The loaves were removed from the proof box and sprayed with a 10% potassium sorbate solution, followed by baking at 420° F. for 12 minutes. After baking, the loaves were removed from the oven and depanned. The loaves were cooled with the flat side down for 10 minutes, and then flipped and allowed to cool for an additional 10 minutes with the flat side up. The loaves were bagged with poly bags with twist ties, and then stored at room temperature (˜72° F.) to observe mold growth.

The results are shown in Table 17 below, which shows the percentage of the loaves for each test that had mold growth, and in FIG. 6.

TABLE 17
Results

| | | | 5% Cassia Oil/ |
|---|---|---|---|
| Day of | Standard | 10% Cassia Oil | 5% Clove Oil |
| Testing | Pan Release | Pan Release | Pan Release |
| Day 10 | 25.00 | 0.00 | 0.00 |
| Day 11 | 25.00 | 0.00 | 0.00 |
| Day 12 | 25.00 | 0.00 | 0.00 |
| Day 13 | 25.00 | 0.00 | 0.00 |
| Day 14 | 25.00 | 0.00 | 0.00 |
| Day 15 | 25.00 | 0.00 | 0.00 |
| Day 16 | 25.00 | 0.00 | 0.00 |
| Day 17 | 25.00 | 0.00 | 0.00 |
| Day 18 | 25.00 | 0.00 | 0.00 |
| Day 19 | 25.00 | 0.00 | 0.00 |
| Day 20 | 25.00 | 0.00 | 25.00 |
| Day 21 | 25.00 | 0.00 | 25.00 |
| Day 22 | 25.00 | 0.00 | 25.00 |
| Day 23 | 25.00 | 0.00 | 25.00 |
| Day 24 | 25.00 | 0.00 | 25.00 |
| Day 25 | 25.00 | 0.00 | 25.00 |
| Day 26 | 25.00 | 0.00 | 25.00 |
| Day 27 | 25.00 | 0.00 | 25.00 |
| Day 28 | 25.00 | 0.00 | 25.00 |
| Day 29 | 25.00 | 0.00 | 25.00 |
| Day 30 | 25.00 | 0.00 | 25.00 |
| Day 31 | 25.00 | 0.00 | 25.00 |
| Day 32 | 25.00 | 0.00 | 25.00 |
| Day 33 | 25.00 | 0.00 | 25.00 |

From the results, it can be seen that although the combination 5% Cassia oil/5% Clove oil prolonged the period before mold growth began, and was an improvement over standard pan release oil by about 10 days, it was not as effective at inhibiting mold growth as the 10% Cassia oil pan release agent.

### Example 5

### White Bread with Liquid Pan Release Agent

In this procedure, a standard straight dough white pan bread formulation was prepared according to the following dough bread making process, using the ingredients in Table 18, below.

TABLE 18
Bread Formulation

| INGREDIENTS | Bakers % | Grams |
|---|---|---|
| Flour | 100 | 3000 |
| Instant Yeast | 1.8 | 54 |
| SSL | 0.5 | 15 |
| Ice Water | 61 | 1830 |
| NFDM | 1.0 | 30 |
| Salt | 2.0 | 60 |
| Sugar | 8.0 | 240 |
| Caparve^{A} | variable | — |
| NOVAMYL ® 10,000 | 0.1 | 3 |
| DEPENDOX ® AXC^{B} | 0.04 | 1.2 |
| Soy Oil | 2 | 60 |

^{A}A Kosher-parve, non-dairy, natural mold inhibitor containing cultured corn syrup solids and wheat starch (available from PTX Food Corp.; Cortlandt Manor, NY).
^{B}A blend of ascorbic acid, ADA, fungal enzymes, and wheat starch (available from Caravan Ingredients, Inc.).

To prepare the dough, the ingredients were added to a McDuffy mixing bowl using a Hobart mixer on the 1st speed setting (low) for 1 minute. For some of the loaves 0% Caparve was used, while 1% Caparve was used in other loaves. The sides of the bowl were scraped with a rubber spatula, and then the ingredients were mixed for an additional 9 minutes on the 2nd speed setting (high) until the dough reached optimum development. The dough was allowed to rest on a wooden bench for 10 minutes, and then divided into 170-gram pieces. The pieces were rounded and then allowed to rest for 5 minutes. Next, a Gemini Straight Grain Moulder was used to sheet and mould the dough pieces, using the settings in Table 19 below.

TABLE 19
Gemini Straight Grain Moulder Settings

| | |
|---|---|
| Rollers | 2/1 |
| Pressure Bd. | 32/30 |

Pup loaf pans (11.5 cm/x 6.5 cm×6 cm h) were greased with a standard pan release oil (Sprafilm) or an inventive pan release agent formulated according to Table 20 below.

TABLE 20
Pan Release Agents
5% Cassia Oil SpraFilm

| | |
|---|---|
| Cassia Oil | 25 g |
| Spra-Film | 475 g |
| Total | 500 g |

10% Cassia Oil/SpraFilm

| | |
|---|---|
| Cassia Oil | 50 g |
| SpraFilm | 450 g |
| Total | 500 g |

To prepare the release agents, the ingredients were added to a 700 mL glass beaker and then stirred with a stir bar for 5 minutes until a homogenous mixture was formed. All ingredients were at 72° F.

Four loaves were prepared for each test. The control loaves did not have any Caparve added to the dough formulation, and use traditional pan release oil. Four loaves were prepared using an inventive 10% Cassia oil pan release agent, without Caparve. Four loaves were prepared using 1% Caparve in the dough and 1% Cassia oil pan release agent. Four loaves were prepared using 1% Caparve and 10% Cassia oil pan release agent. Finally, four loaves were prepared using 1% Caparve and traditional pan release oil. The average weight of the pan release oil or agent in each pan was about 1.27 grams.

The dough was added to the pans and then proofed at 104° F. and 86% humidity for 1 hour. The loaves were removed from the proof box and sprayed with a 10% solution of potassium sorbate, followed by baking at 420° F. for 12 minutes. After baking, the loaves were removed from the oven and depanned. The loaves were cooled for 10 minutes with the bottom side down, and then flipped and allowed to cool for an additional 10 minutes with the flat side up. The loaves were bagged in poly bags with twist ties and stored at room temperature (˜72° F.) to observe mold growth.

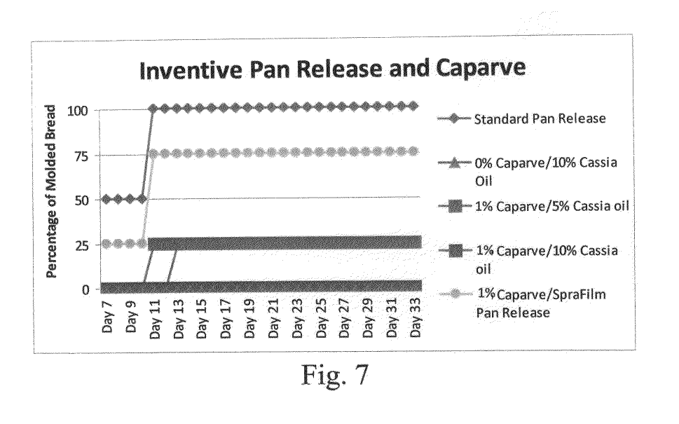

The results are shown in Table 21 below, and in FIG. 7, which indicates the percentage of the loaves observed to have mold growth on the indicated day. The tests were conducted on white pan bread with or without 1% Caparve added to the dough. As evident by the results, the 10% Cassia oil outperformed the 1% Caparve. The combination of 10% Cassia oil release agent and 1% Caparve performed extremely well, with 100% of the loaves showing no mold growth after 33 days.

TABLE 21
Results

| | 0% Caparve | 0% Caparve | 1% Caparve | 1% Caparve | 1% Caparve |
|---|---|---|---|---|---|
| Day | SpraFilm | 10% Cassia Oil | SpraFilm | 5% Cassia Oil | 10% Cassia Oil |
| 7 | 50 | 0 | 25 | 0 | 0 |
| 8 | 50 | 0 | 25 | 0 | 0 |
| 9 | 50 | 0 | 25 | 0 | 0 |
| 10 | 50 | 0 | 25 | 0 | 0 |
| 11 | 100 | 0 | 75 | 25 | 0 |
| 12 | 100 | 0 | 75 | 25 | 0 |
| 13 | 100 | 25 | 75 | 25 | 0 |
| 14 | 100 | 25 | 75 | 25 | 0 |
| 15 | 100 | 25 | 75 | 25 | 0 |
| 16 | 100 | 25 | 75 | 25 | 0 |
| 17 | 100 | 25 | 75 | 25 | 0 |
| 18 | 100 | 25 | 75 | 25 | 0 |
| 19 | 100 | 25 | 75 | 25 | 0 |
| 20 | 100 | 25 | 75 | 25 | 0 |
| 21 | 100 | 25 | 75 | 25 | 0 |
| 22 | 100 | 25 | 75 | 25 | 0 |
| 23 | 100 | 25 | 75 | 25 | 0 |
| 24 | 100 | 25 | 75 | 25 | 0 |
| 25 | 100 | 25 | 75 | 25 | 0 |
| 26 | 100 | 25 | 75 | 25 | 0 |
| 27 | 100 | 25 | 75 | 25 | 0 |
| 28 | 100 | 25 | 75 | 25 | 0 |
| 29 | 100 | 25 | 75 | 25 | 0 |
| 30 | 100 | 25 | 75 | 25 | 0 |
| 31 | 100 | 25 | 75 | 25 | 0 |
| 32 | 100 | 25 | 75 | 25 | 0 |
| 33 | 100 | 25 | 75 | 25 | 0 |

### Example 6

### Bread with Inventive Liquid Pan Release Agent

In this procedure, cassia oil was mixed with the regular pan oil in 5%, 10%, 15%, 20%, or 25% amounts by weight and used to grease bread pans for baking traditional white pan bread. The bread dough also contained 0.1% of calcium propionate mold inhibitor. Control loaves were also prepared using standard pan release oil with no cassia. The dough was prepared according to the sponge and dough method using the ingredients in Table 22 below.

TABLE 22
Bread Formulation

| | % by wt. | 1000 grams |
|---|---|---|
| Sponge | | |
| Flour | 65.0 | 650.0 |
| SSL (optional) | 0.375 | 3.8 |
| STARPLEX ®^{A} 90 | 0.375 | 3.8 |
| Yeast - compressed | 3.5 | 35.0 |
| Soy Oil | 2.0 | 20.0 |
| Water | 39.0 | 390.0 |
| Dough | | 1102.5 |
| Flour | 35.0 | 350.0 |
| Salt | 2.0 | 20.0 |
| Granulated Sugar | 8.0 | 80.0 |
| Calcium Propionate | 0.10 | 1.0 |
| DEPENDOX ® AXC^{B} | 0.060 | 0.6 |
| Yeast - compressed | vary | vary |
| Water (varies) | 17.0 | 170.0 |

^{A}A saturated (high melting) distilled monoglyceride (available from Caravan Ingredients).
^{B}A blend of ascorbic acid, ADA, fungal enzymes, and wheat starch (available from Caravan Ingredients, Inc.).

The sponge was formed by all of the Sponge ingredients in a McDuffy Bowl using a Hobart mixer for 1 minute on the 1st speed setting (low) and 2 minutes on the 2nd speed setting (high). The resulting sponge was placed in a greased sponge trough and fermented for 3 hours in a fermentation cabinet at 85° F. and 86% relative humidity. The dough ingredients were then mixed in a McDuffy Bowl for 30 seconds on low. Next, the sponge was removed from the fermentation cabinet and added to the mixer and mixed for additional 30 seconds on low. The sides of the bowl were scraped down and then the dough was mixed for an additional 6 minutes on high until the dough reached optimum development. The dough was allowed to rest on a wood bench for 10 minutes, and then divided into 530-gram dough pieces. The dough pieces were rounded and allowed to rest for another 5 minutes. Next, an Acme Straight Grain Moulder was used to sheet and mould the dough pieces, using the settings in Table 23 below.

TABLE 23
Acme Straight Grain Moulder Settings

| | |
|---|---|
| 2nd Roller | 2 |
| Pressure Bd. | 2.5 |
| 10″ Pressure Plate | |

Loaf pans were greased with standard pan oil, or with the inventive pan release agent containing varying amounts of Cassia oil. The dough was added to the pans and then proofed at 104° F. and 86% humidity for 1 hour. After proofing, the loaves were removed from the proof box and sprayed with a 10% solution of potassium sorbate, followed by baking at 420° F. for 20 minutes. After baking, the loaves were cooled for 1 hour, and then inoculated by exposing to a high load of mold spores. The loaves were bagged in poly bags with twist ties and stored at room temperature (˜72° F.) to observe mold growth.

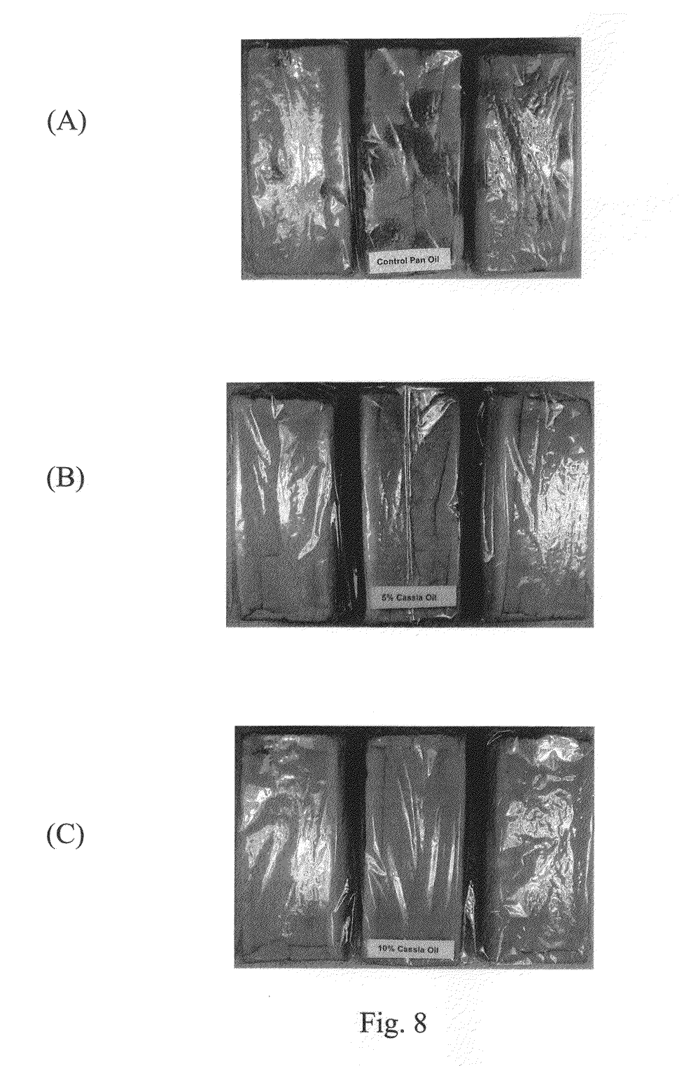

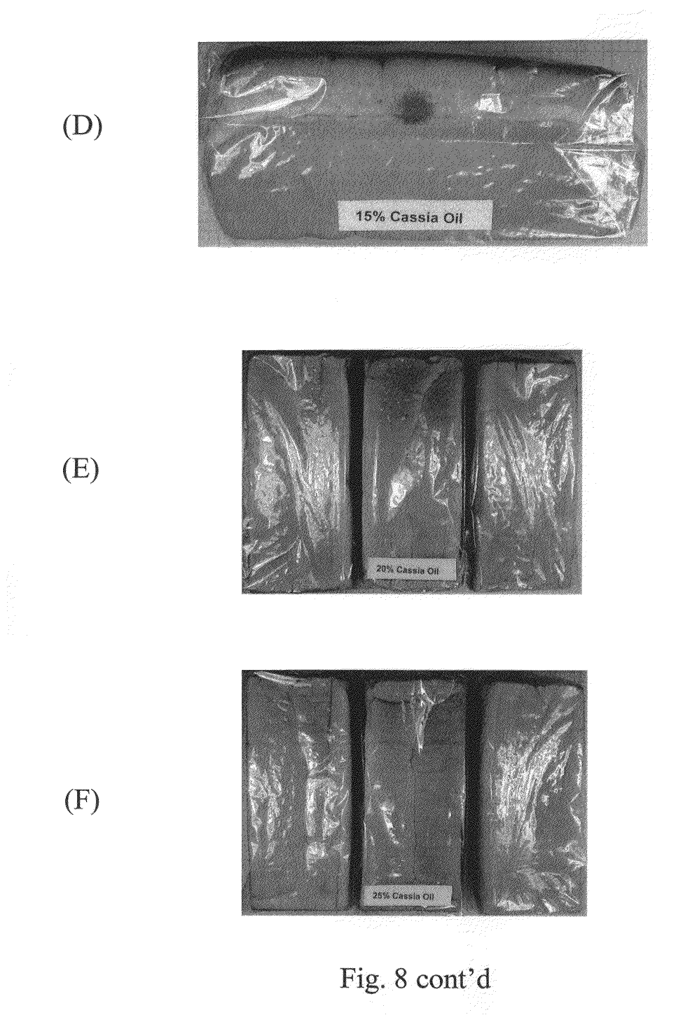

The mold-free shelf life was followed by checking the mold growth in the pan-contacting surfaces. The results showed cassia oil is very effective in mold inhibition. With 5% cassia oil in the pan oil, the inoculated mold-free shelf-life was significantly increased from 7 days of the control to 20 days. A comparison of the mold growth conditions on those bread samples was shown by the pictures taken at day 22 (FIGS. 8(A)-(F)). Up to day 26, no mold growth was observed on the pan-contacting surfaces of the bread samples made with higher levels (>10%) of cassia oil. Cassia oil not only inhibited mold, it also provided a pleasant aroma to the bread.

### Example 7

### White Bread with Liquid Pan Release Agent

In this procedure, a standard straight dough white pan bread formulation was prepared according to the following dough bread making process, using the ingredients in Table 24, below.

TABLE 24
Straight White Bread Dough Formulation

| INGREDIENTS | Bakers % | Grams |
|---|---|---|
| Flour | 100 | 3100 |
| Instant Yeast | 3 | 93 |
| SSL | 0.5 | 15.5 |
| Ice Water | 62 | 1922 |
| NFDM | 1.0 | 31 |
| Sugar | 8.0 | 248 |
| Calcium Propionate | 0.30 | 9.3 |
| NOVAMYL ®^{A} 10,000 | variable | — |
| DEPENDOX ® AXC^{B} | 0.04 | 1.24 |
| Salt | 2.0 | 62 |
| Soy Oil | 2 | 62 |

^{A}For the control loaves 100 ppm NOVAMYL ® 10,000 was used along with traditional SpraFilm Pan Release Oil. The inventive bread loaves were formulated using 1000 ppm NOVAMYL ® 10,000 and the inventive Pan Release Agent.
^{B}A blend of ascorbic acid, ADA, fungal enzymes, and wheat starch (available from Caravan Ingredients, Inc.).

The dough was prepared by mixing all ingredients except salt in a mixing bowl using a Hobart mixer on the 1st speed (low) for 2 minutes. The sides of the bowl were then scraped with a rubber spatula, followed by mixing for 7 minutes at the 2nd speed (high). The salt was added and the dough was mixed on high for another 3 minutes. The dough was allowed to rest on a wood bench for 60 minutes, and then divided into 535-gram dough pieces. The pieces were rounded and then allowed to rest for 5 minutes. Next, a Gemini Straight Grain Moulder was used on the settings outlined in Table 25 below to sheet and mould the dough.

TABLE 25
Gemini Straight Grain Moulder Settings

| | |
|---|---|
| Pressure Bd. | 32/31 |
| Guide Rails | 16/14 |

Loaf pans were greased with standard pan oil, or with the inventive pan release agent containing 10% Cassia oil and flavorings according to Table 26 below.

TABLE 26
10% Cassia Oil Pan Release Agent

| Ingredients | grams |
|---|---|
| Cassia Oil | 12 |
| SpraFilm | 98 |
| Artificial Vanilla Flavor | 10 |
| Artificial Butter Flavor | 10 |

To prepare the release agent, the ingredients were added to a 700 mL glass beaker and then stirred with a stir bar for 5 minutes until a homogenous mixture was formed. All ingredients were at 72° F. The dough was added to the pans greased with the pan release agent and then proofed at 104° F. and 86% humidity for 1 hour. The loaves were baked at 420° F. for 20 minutes. After baking, the loaves were removed from the oven and depanned. The loaves were cooled on a cooling rack for 60 minutes, and then placed in poly bags with twist ties and stored at room temperature (˜72° F.) until tested.

Control bread loaves were baked fresh before each testing session, and always tested at day 4. The inventive bread loaves were baked all on the same day and tested on days 13, 30, and 61 post-baking. Untrained consumer panelists sampled one slice of both breads. Panelists were asked to rate each sample from 1-6 (1=extremely dislike; 6=extremely like) for each of aroma, taste, and softness. Panelists were also asked to choose which sample was preferred overall. Texture analysis was performed in parallel with the panelist sensory testing using a TA.XTPlus Texture Analyser (Texture Technologies Corp.; Scarsdale, N.Y.) and the same settings described in Example 1 above.

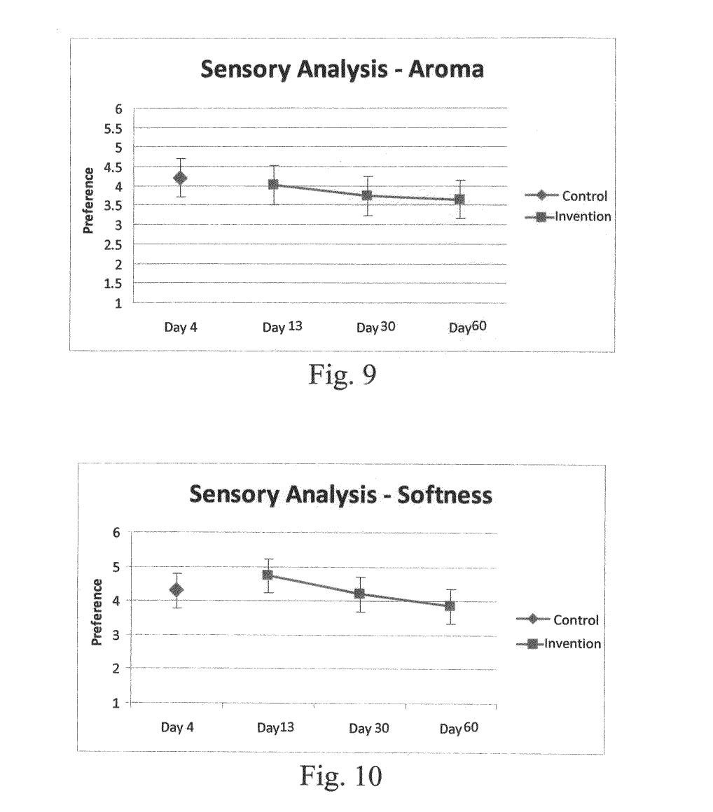

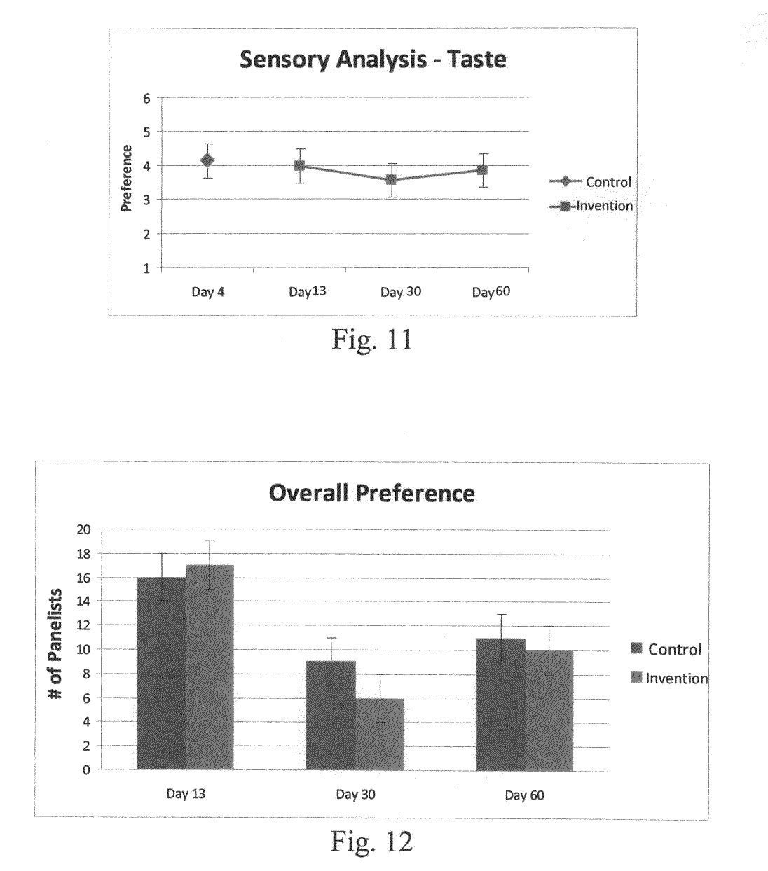

For the sensory testing, no statistically significant differences were detected for overall preference, aroma, flavor, or texture on day 13, 30, or 60 as compared to the 4-day control bread. The results of the panelist sensory testing are shown in Tables 27-28 below, as well as in FIGS. 9-12.

TABLE 27
Sensory Testing Results - Averages for all panelists

| | Day 4 | Day 13 | Day 30 | Day 60 |
|---|---|---|---|---|
| Aroma | | | | |
| Control | 4.21 | — | — | — |
| Invention | — | 4.02 | 3.74 | 3.65 |
| Softness | | | | |
| Control | 4.28 | — | — | — |
| Invention | — | 4.73 | 4.2 | 3.85 |
| Taste | | | | |
| Control | 4.13 | — | — | — |
| Invention | — | 3.98 | 3.55 | 3.85 |

TABLE 28
Overall Preference

| | Day 13 | Day 30 | Day 60 |
|---|---|---|---|
| Control | 16 | 9 | 11 |
| Invention | 17 | 6 | 10 |

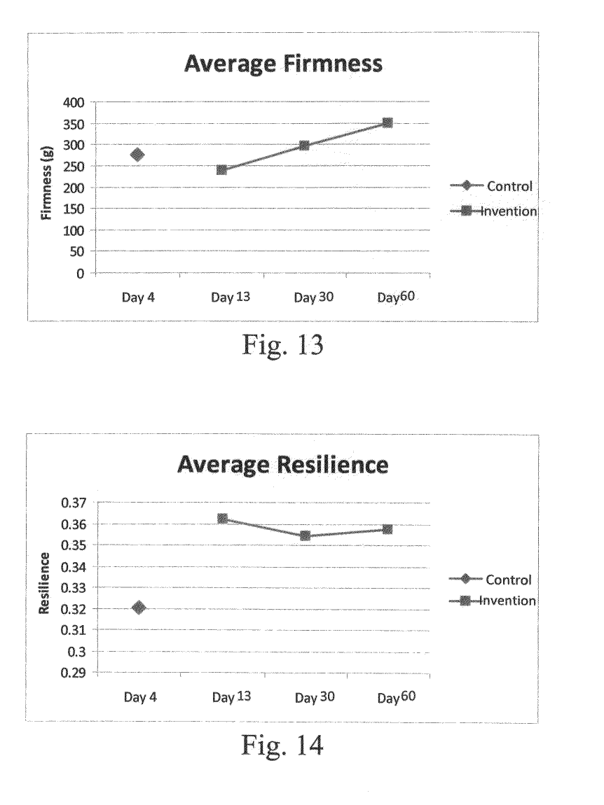

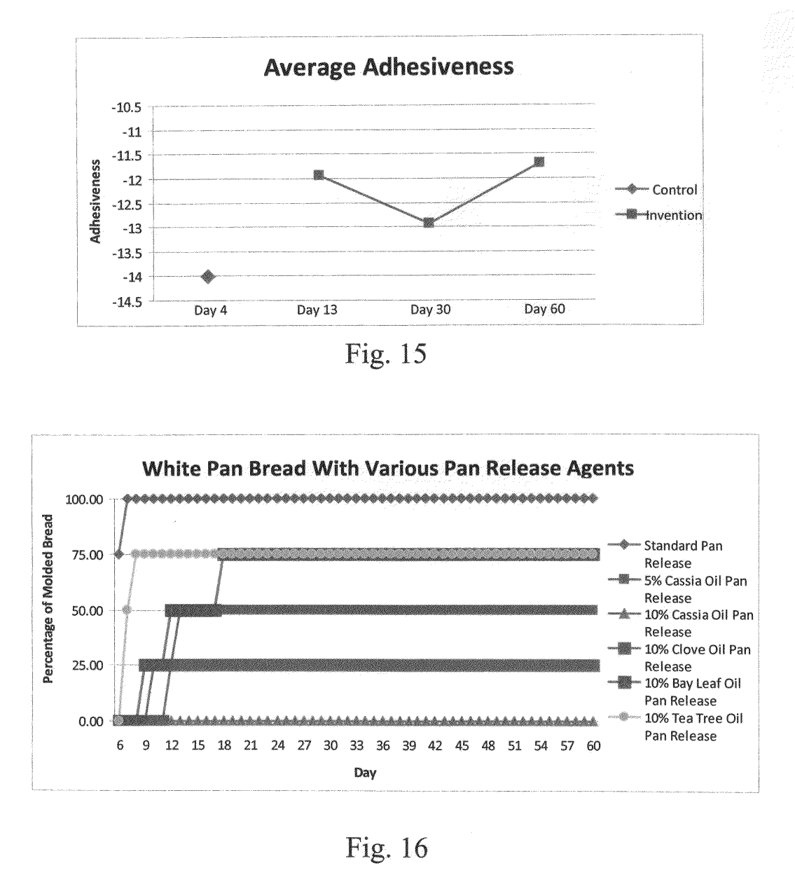

For the texture analysis, there was no major difference in the firmness data until day 60, where 4-day control bread was significantly softer than the 60-day inventive bread. For resilience, the inventive bread was significantly more resilient at day 13 and 30, but showed no difference when compared to the 4-day control bread on day 60. There was no statistically significant difference in adhesiveness on days 13 or 30, but the 4-day control bread was more adhesive than the inventive bread on day 60. All results of the texture analysis are provided in Table 29 below, as well as in FIGS. 13-15.

TABLE 29
Texture Analysis Results (Average of 8 Pairs of Slices)

| | Day 4 | Day 13 | Day 30 | Day 60 |
|---|---|---|---|---|
| Firmness | | | | |
| Control | 274 | — | — | — |
| Invention | — | 239 | 297 | 348 |
| Resilience | | | | |
| Control | 0.32 | — | — | — |
| Invention | — | 0.36 | 0.35 | 0.36 |
| Adhesiveness | | | | |
| Control | −14 | — | — | — |
| Invention | — | −12 | −13 | −12 |

### Example 8

### White Bread Formulation with Various Pan Release Agents

In this Example, pan release compositions were prepared using various essential oils and tested for mold inhibition using a standard white pan bread with no preservatives added to the dough. The pan release compositions were prepared using Bake-Well® 52 Hi Stability, an ultra high-stability pan release oil (available from Caravan Ingredients, Inc.), as the carrier. The pan release agent formulations were prepared using the ingredients in Tables 30-34 below.

TABLE 30
5% Cassia Oil Pan Release Agent

| Ingredient | Grams |
|---|---|
| Cassia Oil | 25 |
| Bake-Well ® 52 | 475 |
| Total | 500 |

TABLE 31
10% Cassia Oil Pan Release Agent

| Ingredient | Grams |
|---|---|
| Cassia Oil | 50 |
| Bake-Well ® 52 | 450 |
| Total | 500 |

TABLE 32
10% Tea Tree Oil Pan Release Agent

| Ingredient | Grams |
|---|---|
| Tea Tree Oil | 50 |
| Bake-Well ® 52 | 450 |
| Total | 500 |

TABLE 33
10% Clove Oil Pan Release Agent

| Ingredient | Grams |
|---|---|
| Clove Oil | 50 |
| Bake-Well ® 52 | 450 |
| Total | 500 |

TABLE 34
10% Bay Leaf Oil Pan Release Agent

| Ingredient | Grams |
|---|---|
| Bay Leaf Oil | 50 |
| Bake-Well ® 52 | 450 |
| Total | 500 |

Each pan release agent was prepared by scaling the ingredients into a 700 mL glass beaker, inserting a stir bar, and mixing for 5 minutes to form a homogenous mixture. All ingredients were at 72° F. (room temperature).

To prepare the white pan bread, the ingredients in Table 35 below were mixed in a McDuffy Bowl using a Hobart mixer on the 1st speed setting (low) for 1 minute. The sides of the bowl were scraped and the ingredients were mixed on the 2nd speed setting (high) for 7 minutes.

TABLE 35
White Pan Bread Formulation

| INGREDIENTS | Baker's % | Grams |
|---|---|---|
| Flour | 100 | 900 |
| Instant Yeast | 1.8 | 16.2 |
| SSL | 0.5 | 4.5 |
| Ice Water | 60 | 540 |
| NFDM | 1.0 | 9 |
| Salt | 2.0 | 18 |
| Sugar | 8.0 | 72 |
| NOVAMYL ® 10,000 | 0.1 | 0.9 |
| DEPENDOX ® AXC^{A} | 0.04 | 0.36 |
| Soy Oil | 2.0 | 18 |

^{A}A blend of ascorbic acid, ADA, fungal enzymes, and wheat starch (available from Caravan Ingredients, Inc.).

Once formed, the dough was allowed to rest on a wooden bench for 10 minutes, and then divided into 170-gram dough pieces. The dough pieces were rounded and then allowed to rest for 5 minutes. Next, a Gemini Straight Grain Moulder was used on the settings outlined in Table 36 below to sheet and mould the dough.

TABLE 36
Gemini Straight Grain Moulder Settings

| | |
|---|---|
| Rollers | 2/1 |
| Pressure Bd. | 32/30 |

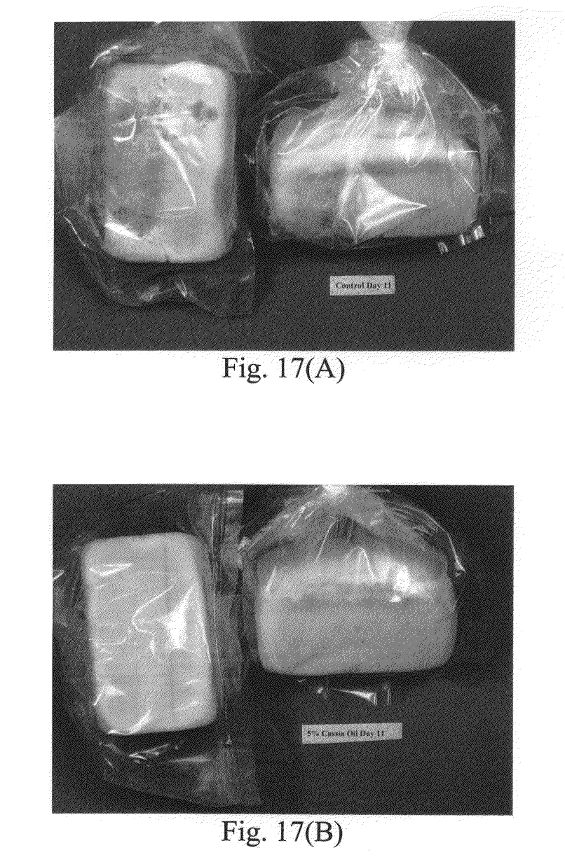

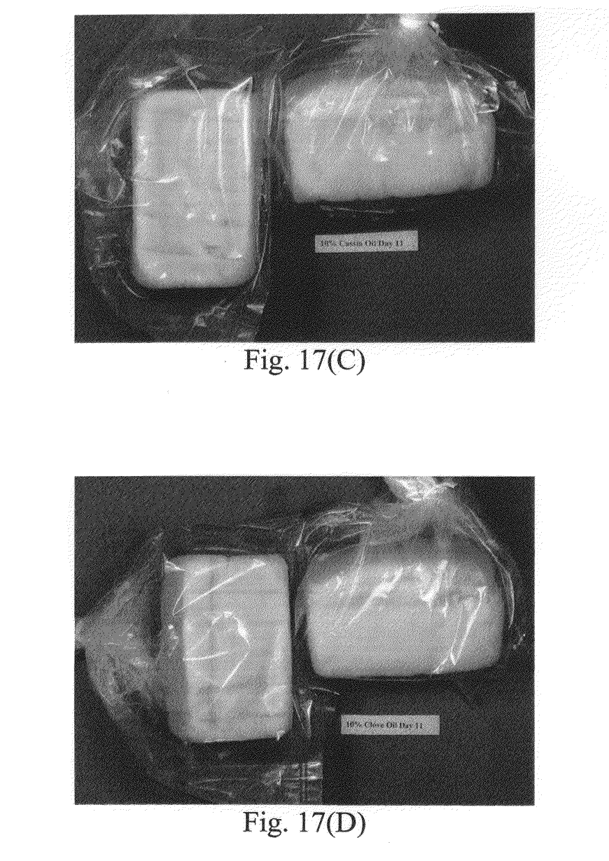

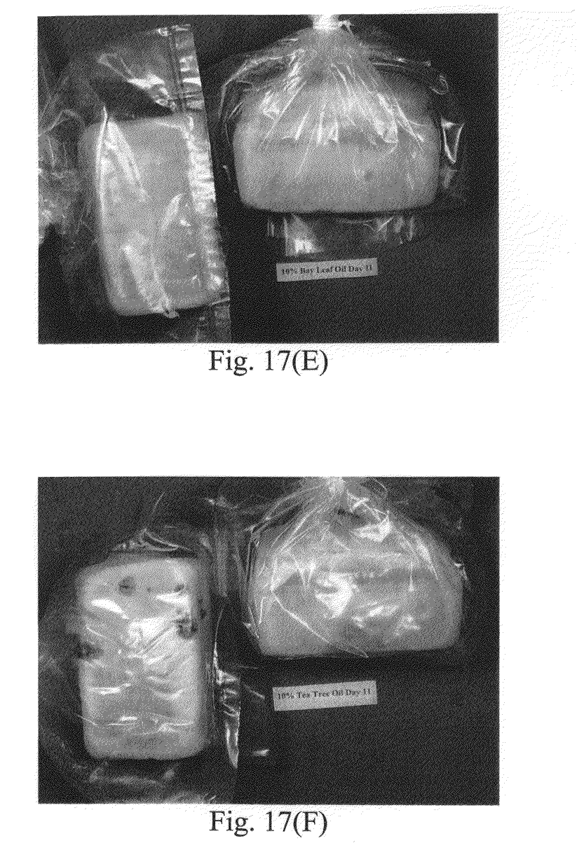

Loaf pans were brushed with about 1.27 grams each of the standard pan oil, or with the inventive pan release agents described above. Four pans were prepared for each pan release agent formulation and the control standard pan oil. The dough was added to the greased pans and then proofed at 104° F. and 86% humidity for 70 minutes. The loaves were then removed from the proof box, and the top of each loaf was sprayed with a 10% sorbate solution. The loaves were then baked at 420° F. for 12 minutes. After baking, the loaves were removed from the oven and depanned. The loaves were cooled bottom-side-down for 10 minutes, and then flipped over and cooled for an additional 10 minutes. The cooled loaves were then placed in poly bags with twist ties and stored at room temperature (˜72° F.) to observe mold growth over a period of 60 days. The cassia oil outperformed the other oils, and the 10% cassia oil loaves remained mold free for over 46 days. However, the other essential oils and lower level of cassial oil demonstrated mold inhibition over the loaves baked using only the standard pan release oil. The results are shown in Table 37 below, as well as in FIG. 16. Photographs of the bread were also taken on Day 11 as shown in FIGS. 17(A)-(F).

TABLE 37
% of Moldy Bread Using Various Pan Release Formulations

| | Standard Pan | 5% Cassia Oil | 10% Cassia Oil | 10% Clove Oil | 10% Bay Leaf Oil | 10% Tea Tree |
|---|---|---|---|---|---|---|
| Day | Release Oil | Pan Release | Pan Release | Pan Release | Pan Release | Oil Pan Release |
| 6 | 75^{A} | 0 | 0 | 0 | 0 | 0 |
| 7 | 100 | 0 | 0 | 0 | 0 | 50 |
| 8 | 100 | 0 | 0 | 0 | 0 | 75 |
| 9 | 100 | 0 | 0 | 0 | 25 | 75 |
| 10 | 100 | 25 | 0 | 0 | 25 | 75 |
| 11 | 100 | 25 | 0 | 0 | 25 | 75 |
| 12 | 100 | 25 | 0 | 25 | 50 | 75 |
| 13 | 100 | 50 | 0 | 25 | 50 | 75 |
| 14 | 100 | 50 | 0 | 25 | 50 | 75 |
| 15 | 100 | 50 | 0 | 25 | 50 | 75 |
| 16 | 100 | 50 | 0 | 25 | 50 | 75 |
| 17 | 100 | 50 | 0 | 25 | 50 | 75 |
| 18 | 100 | 50 | 0 | 25 | 75 | 75 |
| 19 | 100 | 50 | 0 | 25 | 75 | 75 |
| 20 | 100 | 50 | 0 | 25 | 75 | 75 |
| 21 | 100 | 50 | 0 | 25 | 75 | 75 |
| 22 | 100 | 50 | 0 | 25 | 75 | 75 |
| 23 | 100 | 50 | 0 | 25 | 75 | 75 |
| 24 | 100 | 50 | 0 | 25 | 75 | 75 |
| 25 | 100 | 50 | 0 | 25 | 75 | 75 |
| 26 | 100 | 50 | 0 | 25 | 75 | 75 |
| 27 | 100 | 50 | 0 | 25 | 75 | 75 |
| 28 | 100 | 50 | 0 | 25 | 75 | 75 |
| 29 | 100 | 50 | 0 | 25 | 75 | 75 |
| 30 | 100 | 50 | 0 | 25 | 75 | 75 |
| 31 | 100 | 50 | 0 | 25 | 75 | 75 |
| 32 | 100 | 50 | 0 | 25 | 75 | 75 |
| 33 | 100 | 50 | 0 | 25 | 75 | 75 |
| 34 | 100 | 50 | 0 | 25 | 75 | 75 |
| 35 | 100 | 50 | 0 | 25 | 75 | 75 |
| 36 | 100 | 50 | 0 | 25 | 75 | 75 |
| 37 | 100 | 50 | 0 | 25 | 75 | 75 |
| 38 | 100 | 50 | 0 | 25 | 75 | 75 |
| 39 | 100 | 50 | 0 | 25 | 75 | 75 |
| 40 | 100 | 50 | 0 | 25 | 75 | 75 |
| 41 | 100 | 50 | 0 | 25 | 75 | 75 |
| 42 | 100 | 50 | 0 | 25 | 75 | 75 |
| 43 | 100 | 50 | 0 | 25 | 75 | 75 |
| 44 | 100 | 50 | 0 | 25 | 75 | 75 |
| 45 | 100 | 50 | 0 | 25 | 75 | 75 |
| 46 | 100 | 50 | 0 | 25 | 75 | 75 |
| 47 | 100 | 50 | 0 | 25 | 75 | 75 |
| 48 | 100 | 50 | 0 | 25 | 75 | 75 |
| 49 | 100 | 50 | 0 | 25 | 75 | 75 |
| 50 | 100 | 50 | 0 | 25 | 75 | 75 |
| 51 | 100 | 50 | 0 | 25 | 75 | 75 |
| 52 | 100 | 50 | 0 | 25 | 75 | 75 |
| 53 | 100 | 50 | 0 | 25 | 75 | 75 |
| 54 | 100 | 50 | 0 | 25 | 75 | 75 |
| 55 | 100 | 50 | 0 | 25 | 75 | 75 |
| 56 | 100 | 50 | 0 | 25 | 75 | 75 |
| 57 | 100 | 50 | 0 | 25 | 75 | 75 |
| 58 | 100 | 50 | 0 | 25 | 75 | 75 |
| 59 | 100 | 50 | 0 | 25 | 75 | 75 |
| 60 | 100 | 50 | 0 | 25 | 75 | 75 |

^{A}A score of 75 means that three out of the four loaves of bread were moldy. Likewise, 50 means that two out of the four loaves were moldy.

We claim:

1. An antimicrobial pan release agent comprising an essential oil dispersed or dissolved in a fat- or oil-based carrier.

2. The pan release agent of claim 1, said pan release agent remaining stable for at least about 15 days under ambient conditions.

3. The pan release agent of claim 1, wherein said carrier is a liquid carrier comprising an ingredient selected from the group consisting of vegetable oils, mineral oils, emulsifiers, antioxidants, petroleum jelly, phosphated monoglycerides, calcium carbonate, silica, and mixtures thereof.

4. The pan release agent of claim 3, said carrier having a smoke point of from about 225° F. to about 500° F.

5. The pan release agent of claim 1, wherein said carrier is a solid/semi-solid carrier comprising an ingredient selected from the group consisting of vegetable oils, emulsifiers, antioxidants, grain flour, starch, and mixtures thereof.

6. The pan release agent of claim 5, said carrier having a melting point of from about 80° F. to about 150° F.

7. The pan release agent of claim 1, said pan release agent consisting essentially of at least one essential oil and a carrier, said carrier consisting of vegetable oil.

8. The pan release agent of claim 1, said pan release agent being substantially free of chemical preservatives, natamycin, nisin, other antimicrobial agents, water, alcohol, or a combination thereof.

9. The pan release agent of claim 1, said essential oil being selected from the group consisting of cassia oil, cinnamon oil, clove oil, bay leaf oil, tea tree oil, rosemary oil, garlic oil, mustard oil, ginger oil, onion oil, thyme oil, mint oil, peppermint oil, and combinations thereof.

10. The pan release agent of claim 1, said pan release agent further comprising at least one chemical preservative.

11. A method of extending the shelf life of a dough- or batter-based product comprising:
treating the surface of a dough or batter with an antimicrobial pan release agent comprising an essential oil dispersed or dissolved in a fat- or oil-based carrier; and
baking said dough or batter to yield a baked product having an extended mold-free shelf life.

12. The method of claim 11, wherein said baking comprises baking said dough or batter in a baking pan.

13. The method of claim 12, wherein said treating comprises applying said pan release agent to a dough- or batter-contacting surface of said pan, said method further comprising adding said dough or said batter to said pan after said treating and prior to said baking.

14. The method of claim 13, further comprising applying said pan release agent or a chemical preservative to an exposed surface of said dough or batter not in contact with said pan after adding said dough or batter to said pan and prior to said baking.

15. The method of claim 13, further comprising applying said pan release agent or a chemical preservative to an exposed surface of said dough or batter not in contact with said pan after said baking.

16. The method of claim 12, wherein said method further comprises adding said dough or said batter to said pan prior to said treating, and wherein said treating comprises applying said pan release agent to an exposed surface of said dough or batter not in contact with said pan.

17. The method of claim 16, further comprising applying said pan release agent to a dough- or batter-contacting surface of said pan prior to adding said dough or batter to said pan.

18. The method of claim 12, further comprising removing said baked product from said baking pan, and applying said pan release agent to a surface of the baked product.

19. The method of claim 11, wherein said baked product has a mold-free shelf life of at least about 30 days under ambient conditions.

20. The combination of:
a food product having an outer surface, said outer surface comprising a pan-contacting surface and an exposed surface; and
a coating of antimicrobial pan release agent adjacent said pan-contacting surface, said antimicrobial pan release agent comprising an essential oil dispersed or dissolved in a fat- or oil-based carrier.

21. The combination of claim 20, further comprising a coating of said antimicrobial pan release agent adjacent said exposed surface.

22. The combination of claim 20, further comprising a coating of a chemical or natural preservative adjacent said exposed surface.

23. The combination of claim 20, said food product having a mold-free shelf life of at least about 60 days under ambient conditions

24. The combination of claim 20, said food product being a dough- or batter-based baked product.

25. The combination of claim 24, said baked product being selected from the group breads, buns, rolls, English muffins, bagels, laminated doughs, pizza crust, pastries, tortillas, crumpets, pretzels, cakes, cupcakes, muffins, quick breads, waffles, and pancakes.

26. The combination of claim 20, said food product comprising an anti-staling enzyme.

27. The combination of claim 26, said anti-staling enzyme being a maltogenic exoamylase.
